(19) United States
(12) Patent Application Publication
(10) Pub. No.: US 2009/0199090 A1
(43) Pub. Date: Aug. 6, 2009

(54) Method and system for digital file flow management

(76) Inventors: Timothy Poston, Karnataka (IN); Tomer Shalit, Holmsund (SE); Mark Dixon, Skarholmen (SE); Anna Westerberg, Umea (SE)

Correspondence Address: NIXON & VANDERHYE, PC, 901 NORTH GLEBE ROAD, 11TH FLOOR, ARLINGTON, VA, 22203, US

(21) Appl. No.: 12/292,640

(22) Filed: Nov. 21, 2008

Related U.S. Application Data
(60) Provisional application No. 60/989,851, filed on Nov. 23, 2007.

(51) Int. Cl. G06F 17/30; G06F 17/00

(52) U.S. Cl. 715/255; 707/102; 707/E17.044

(57) ABSTRACT

We construct a systematic scheme of information concerning provenance among digital objects, make this information available to the user, and use it to modify the effect of user's actions. Such relationships are derived by comparison of elements in the files or by making records when creating them. This information may be displayed by a view of a descent tree, a flow diagram, or internal markup of a combined view of object content. The provenance structure enables selection of related subsets for search, constraints on search such as ‘root occurrence’ or ‘unmerged occurrences’, and selection of appropriate objects to merge or respond to. It defines the active set of objects for any chosen time, enabling a display of commonality and difference among versions at any stage of a project involving one or more collaborators, with or without one of them having final authority over the suggestions of the others. Applications include but are not limited to project flow management including bug reporting and correction, collaborative authoring (by document circulation or by wiki), enhanced chat, enhanced navigation among available objects, and retrieval of objects by following provenance pathways.

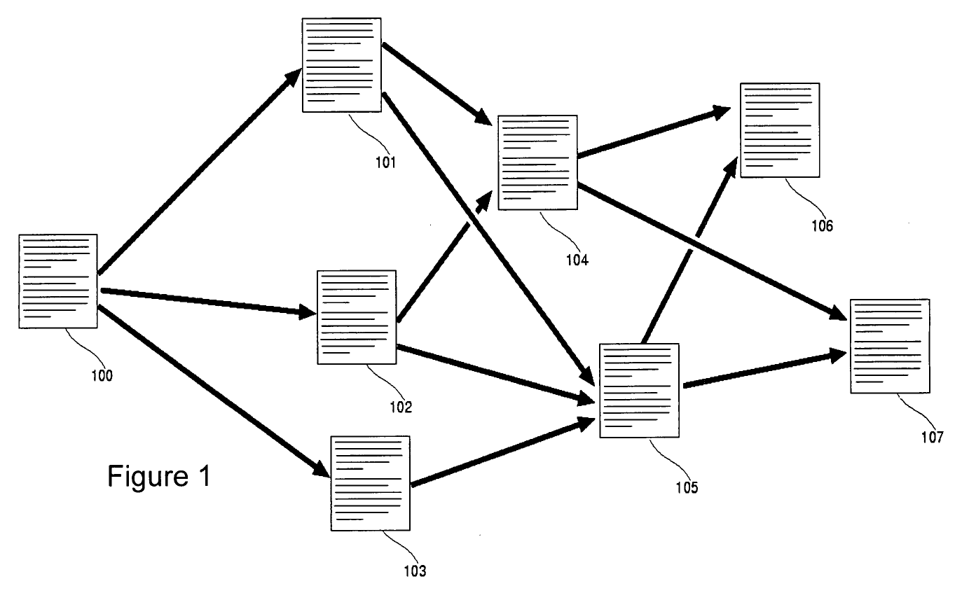

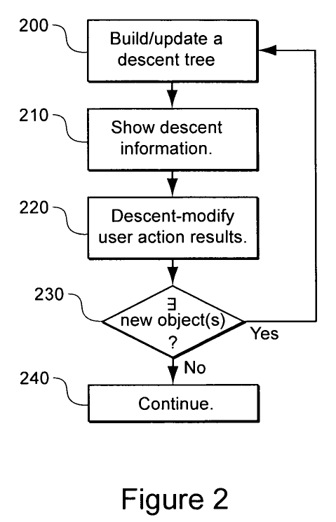

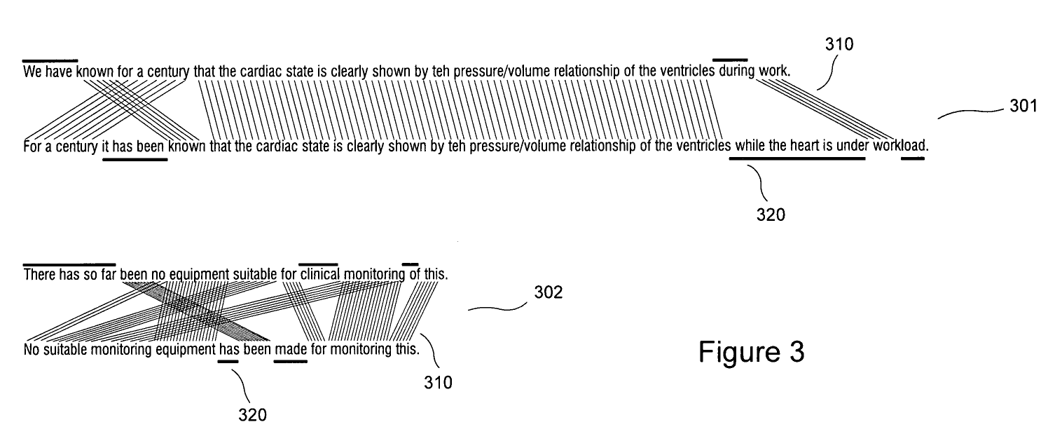

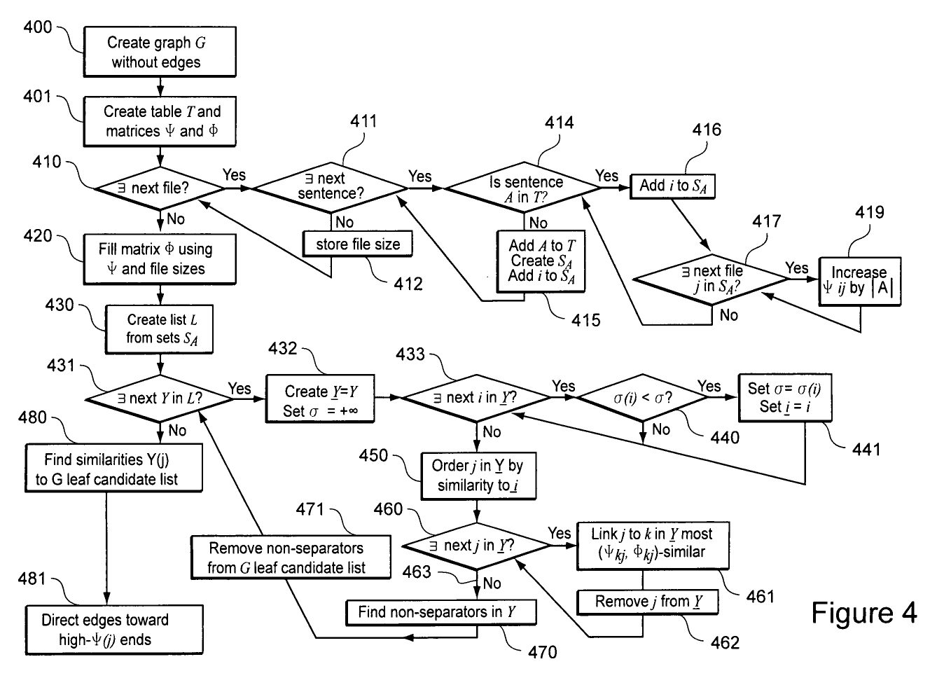

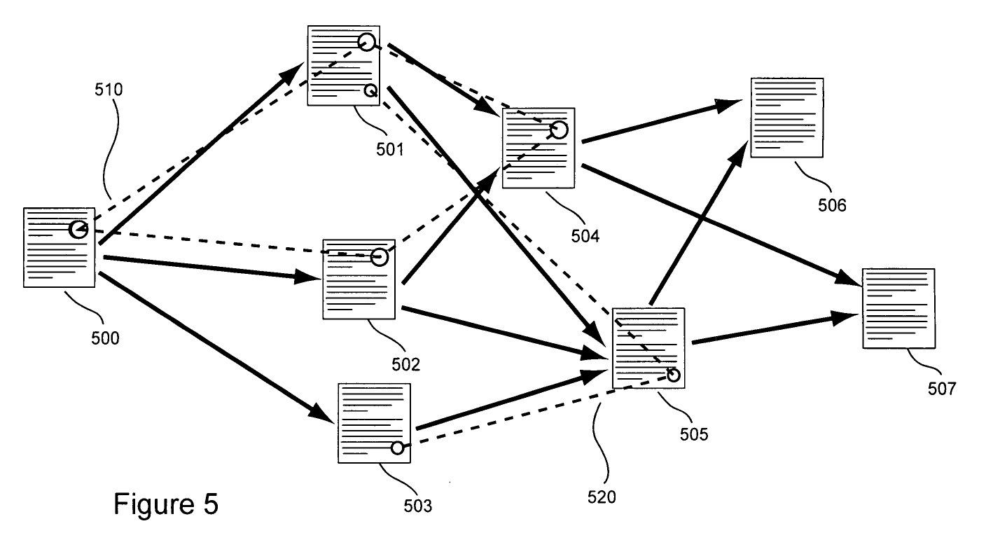

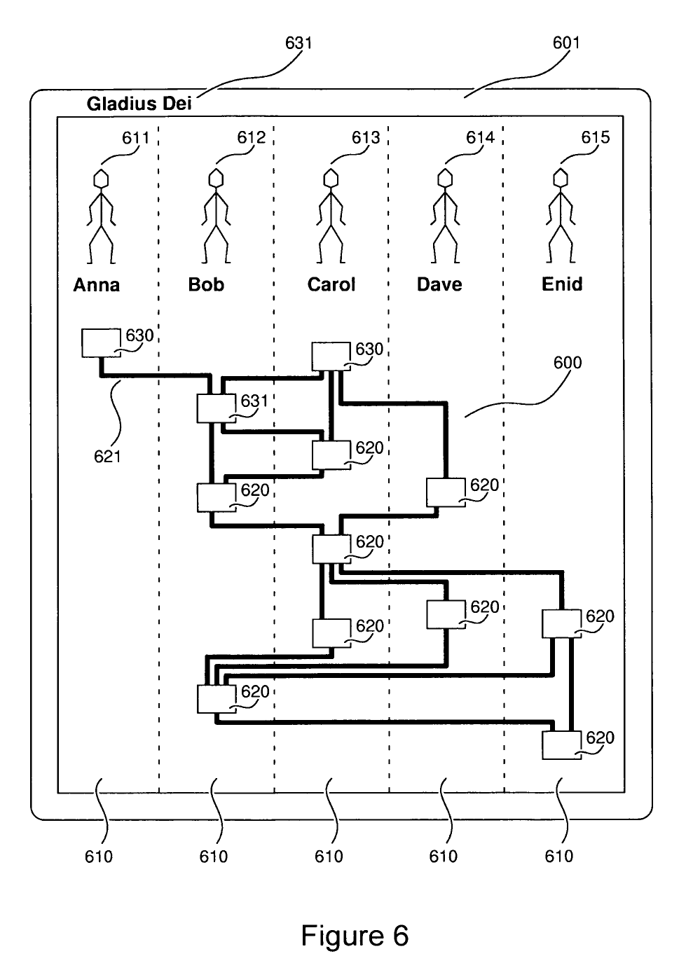

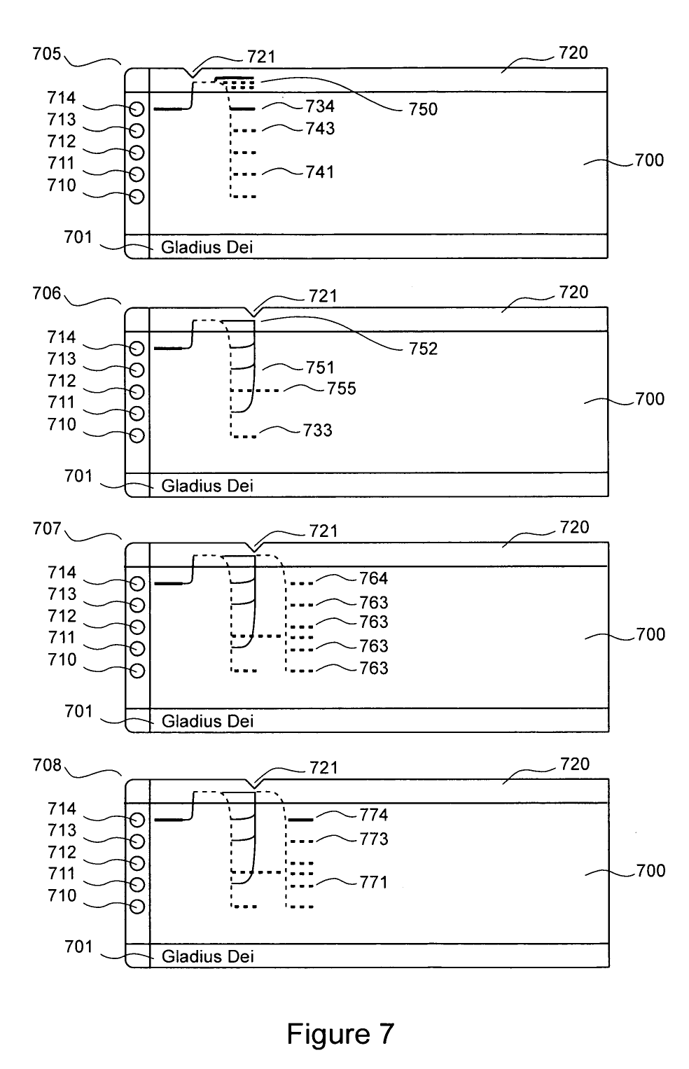

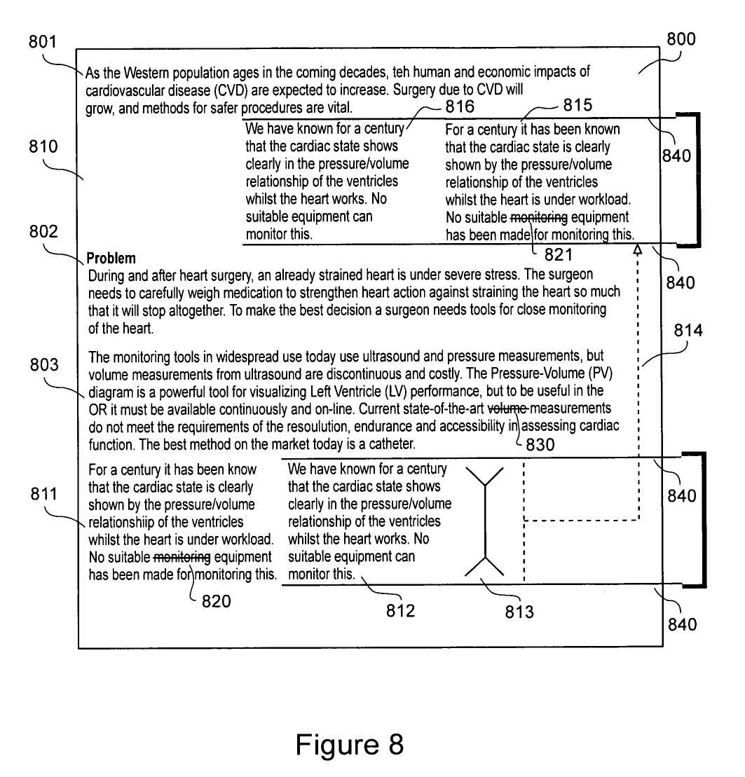

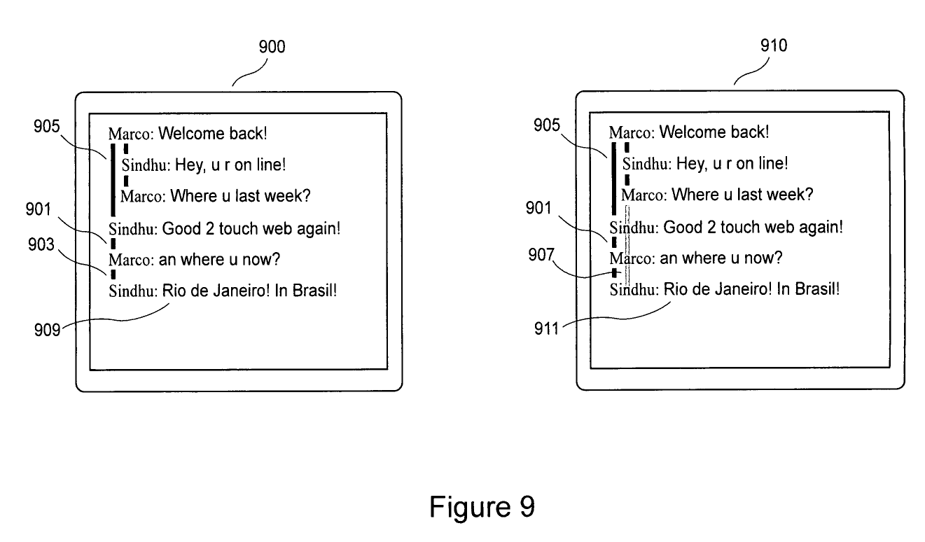

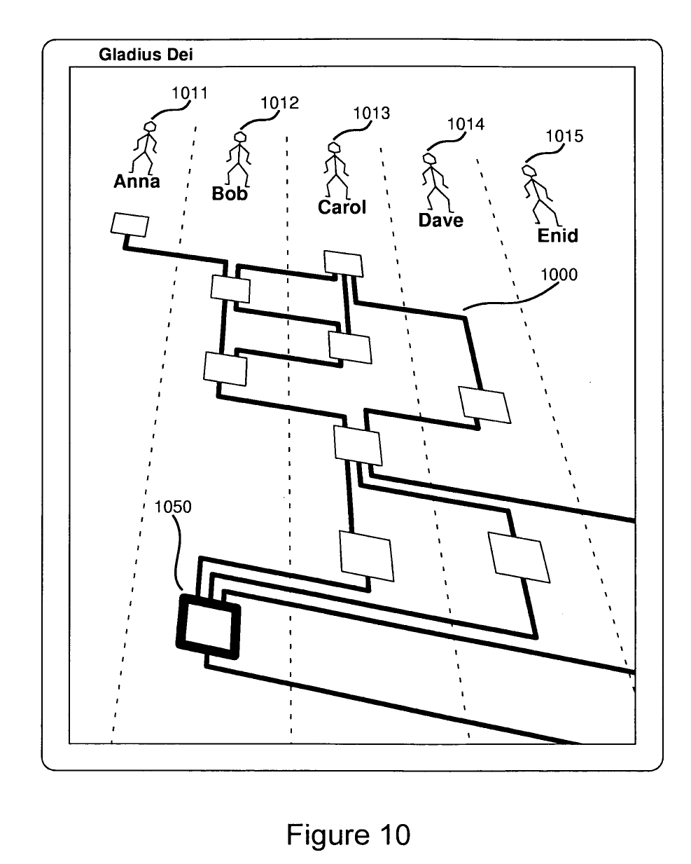

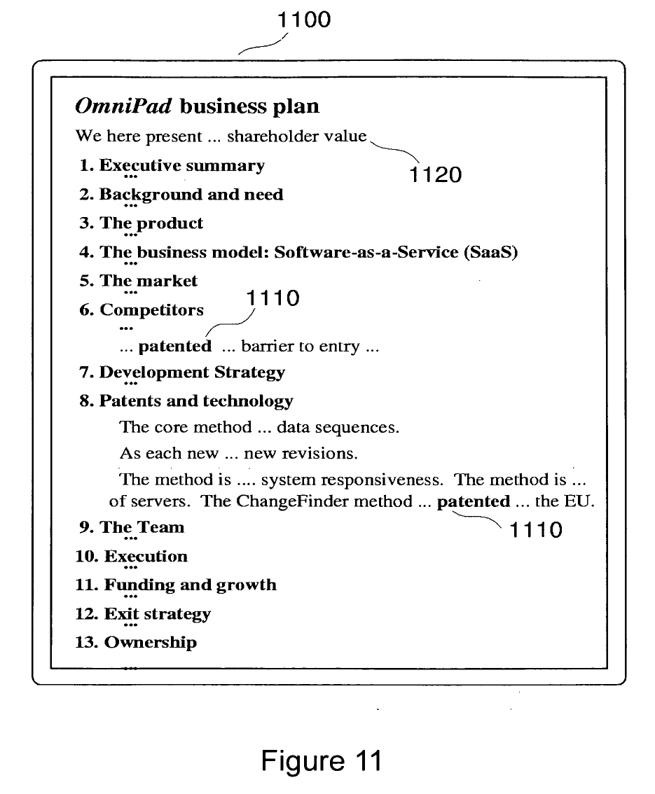

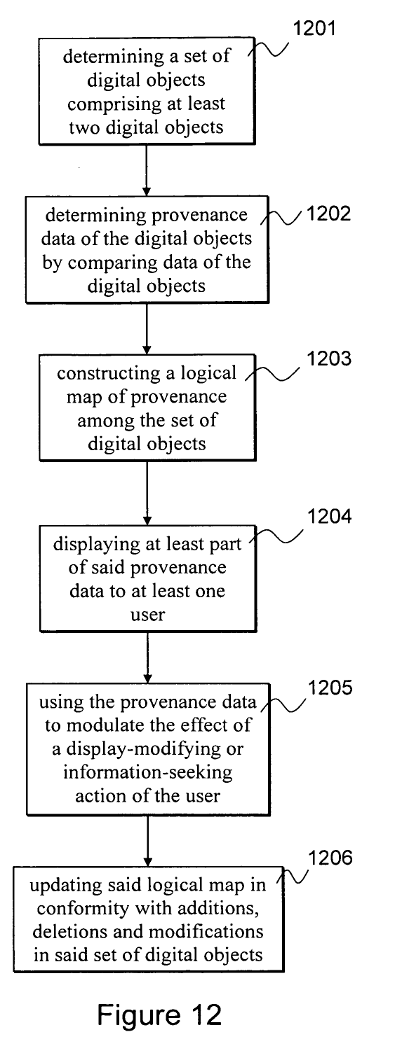

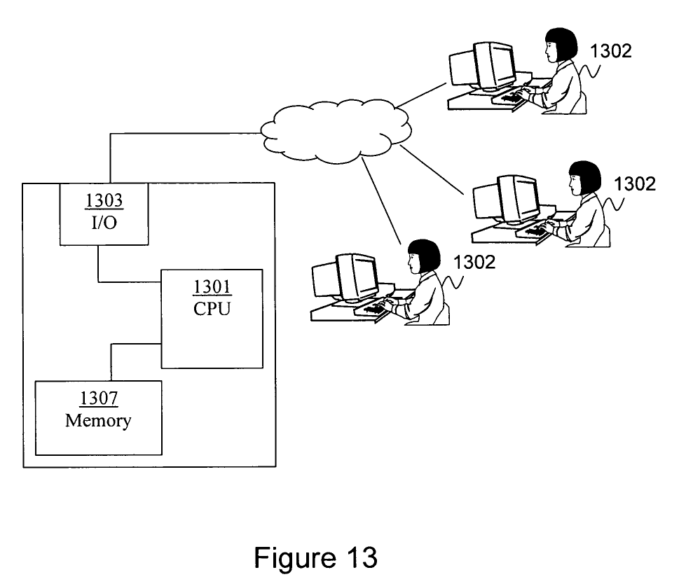

### CROSS REFERENCE TO RELATED APPLICATION

This present application claims the benefit of U.S. Provisional Application No. 60/989,851, filed 23 Nov. 2007, the entire contents of which is hereby incorporated by reference.

### BACKGROUND OF THE INVENTION

For convenience in what follows we refer to information stored as an identifiable body of data as a ‘file’, and sometimes as a ‘document’, but the restrictive sense of these terms are to be taken as exemplary, rather than limiting. The discussion below is intended to cover (wherever the context admits) other stored pieces of structured data, such as a spreadsheet, a bitmapped image, a song, a multi-layer image such as created by PhotoShop™, a database, a wiki, a web log, a web page, an executable computer program or source code, a bug report, a part model created by scanning or by computer-aided design, a medical or geological scan, an internet conversation over ‘chat’ or a submission to such a session, a recording of a performance (in any medium) of a telephone call, of the sound of a hurricane, or any other sequentially structured event, a pointer such as a URL to an information source such as an interactive web page, a playable game, or other item which creates its response according to user input, making it hard for a search engine to index for content. Our usage of the words ‘file’ and ‘document’ does, however, exclude unitary items of information, such as a phone number.

Today's software serves users poorly, faced with the lake of files and records that even one user creates on one computer. As an interface to the sea of material within an organisation, or the ocean that is the web, today's software is a tool that only an advertiser can praise. Fundamentally new methods are needed for organizing and finding the material that one has oneself stored, or that others have, and for moving around in it.

### Provenance and Flow

Much of the brain's information structure is a mystery, but we know that much of it revolves around the flow of development, movement and work that every item is a part of. We endlessly adapt one thing from another, or combine things, and continue to think of origins—at least in part—via their roots. “That piece about the French glacier that you adapted from my diary and illustrated with Jan's photos and images from the first illustrated Frankenstein” is vividly specific, to a human, particularly one who has read the book and has the image of pursuit over endless ice, which the Mer de Glace might have suggested to the author. It fails to translate into a search query, for any existing engine. The human question has related an item to a flow of work, development and personal connection for which today's search systems have no representation. Even the immediate steps by which one item derives from another are rarely tracked and never searchable. The overall flow which these steps make up is a key part of the user's awareness of the work, but no better reflected in the computer's records or presentation than it was by the physical filing cabinets metaphorized by the virtual ‘folders’ or ‘directories’ of today's operating systems.

Our view is that provenance is important enough to be useful as a systematic aspect of data storage, and that provenance and workflow can be natural elements of the human/machine interface even when they must be reconstructed rather than looked up in a systematic store. The fact that one document derives at least partly from another is often visible to a human reader from the ‘content’ of the file: that is, the stored material which is displayed explicitly (for example, as text) when the document is opened. If one document displays a subset of the other between quotation marks, or in a contrasting size or font, or indented, or if it discusses it, the reader perceives the quoted document as part of the history of the quoting one, even without creation dates. This is not easy for software. Other instances are harder (and can be contentious) even for humans.

It is thus of interest both to extract provenance information from content, where possible, and to add provenance information to easily read ‘metadata’ attached to the file, whether embedded directly among the 1s and 0s it contains, or linked to it by some system of pointers in a local or distributed operating system. Many documents already have simple metadata attached already, such as dates for creation and for latest modification, author name, etc., which are usually omitted when displaying content. (Often an application has a menu system by which a user can call up metadata items for display.)

The invention described below includes the systematic inclusion of provenance information in the data for a file (whether this information derives from content analysis or from tracking the process by which the file is created or modified, whether a program such as an operating system (OS) or application stores the information and links it to the file or the information is embedded in metadata contained by the file), and the systematic use of such information in presenting a set of files to the user. To the extent of our knowledge, there is no previously existing example or disclosure of this approach. Except where software has absorbed an existing structure, such as the bibliography list, provenance is not even a small part of how a computer relates to what it holds. (What a computer “knows” is too strong a verb, probably for decades yet.) Consider a few of the ways in which this obstructs the user:
i. Save an attachment from an e-mail, and the OS will put it in a particular folder, with a timestamp: a time stamp indicating when you saved it. Unless the file format includes internal records, the original author and creation date are lost to you. A .doc file records these, and the latest modification date, but there is never a mark of who mailed it to you, in what context. To find “that piece about the brain that Sergei sent me” you must search either your old mail (where it may have been deleted to save Inbox space) or your saved files which mention the brain which may be very numerous.
ii. You take a photo of your grandchild, and send it to your co-granny. You both have low bandwidth, so the full 1 MB file is hard to send (and has detail she will not see on a normal resolution screen). You send a smaller version, giving it a name like JimExplodingChocolate.jpg. Later, face to face; she asks for a high-res copy to print You whip out your memory stick and laptop and . . . go hunting the original, still ‘P3170011.JPG’ as the system named it. You do not find it, among all your camera files, before her plane leaves.
iii. Where did that Assyrian leaping image you used in your essay on the history of jumping, come from? You have a use now for what you cropped out, back then, but where is it? There is no trace.
iv. The business plan that you and a finance expert and an engineer and a market specialist and a lawyer have been writing has been bouncing around so long that when Sue sends you a new version you have no idea which ones she drew from, and which ones you need to check for things she may have left out.
v.

None of these things can be fixed at the interface level alone, or by improvement of search tools, as such. The underlying system has provenance amnesia.

The fundamental assumption of traditional file management is that there exists a correct version of any file, which exists at a particular binary address. (It may have segments distributed over a disk drive, but this is kept as hidden as possible, not only from the user but from programs.) The addresses are placed in a hierarchical structure, which may be shown to the user as a tree, or as a scheme of windows and sub-windows, with little pictures of folders to help the user remember the uniqueness of ‘the’ location for the item—that is, of the folder that registers its binary address—though the folder hierarchy is a mere extrinsic collection of named pointers. (When a file is ‘moved’ its 1s and 0s normally stay where they are on the disk, with only the pointer passed from one folder's list to another's.) A ‘link’ or ‘short cut’ is clearly marked as such, to remind the user that the item ‘really’ has a unique folder as home.

A current alternative to a folder window is a display of results for a search, usually as a flat list, though it may be laid out by ranking, date or file type, or by on-the-fly clustering, or shown as a ‘smart window’ that can update the search. The display does not diagram relation of the search results to a folder hierarchy (the only durable grouping on offer), let alone show provenance.

Folders and search lists leave a lot of work to the mind of the user. The folders in any current OS permit the user to add ad hoc provenance labels like initials or a date to a filename (save from v3.doc as v3joeEdit.doc or v3Aug8B.doc), but collaborating users rarely agree on a system for this, and the OS contributes nothing directly. Without a greatly improved computable theory of human thought we do not expect software to suggest Shelley's visit to the Mer de Glace as part of the provenance of Frankenstein, but the invention described below can do better than ‘filed when, in what folder, under what name’.

### Sharing and Collaboration

When a draft document normally existed in one physical copy, whoever had it, changed it. A circulating typescript, or a postcard with a steadily accreting collage, or the cardboard folder of a patient's medical records and X-rays, fitted this model. With photocopying, and now digital copying, multiple variants coexist. Even one author/creator may create a set of documents with a complex history: with more than one, this is usual. Drawing 1 (reproduced from Poston, Shalit and Dixon, “A Method and System for Facilitating the Production of Documents”, USPTO application No. 60/884,230, 10 Jan. 2007, hereby incorporated by reference) shows a common scenario of current co-authorship in practice, with a time-line from left to right. One author creates a first draft 100, and sends it around to the other people whose name will be on the document. Two of these people begin work on it, and circulate their versions 101 and 102. Another author (perhaps the creator of version 101, perhaps a fourth contributor) reads these versions and absorbs those of their changes she likes into a new file 104, with her own additions and deletions. Meanwhile, yet another author has created file 103 from the original file 100, with some changes that are the same as for 101 or 102 (for example, every author is likely to change “growths misalignments” [a real example] into “gross misalignments”), and with other changes that are not in files 101, 102 or 104. Some other author who has already contributed, or has not, simultaneously uses 101, 102 and 103 to create file 105. Two distinct authors then independently use 104 and 105 to create their own distinct conflations 106 and 107, with—once again—their distinct additions. Of special importance to the next contributor are the ‘leaf nodes’ of this directed graph: those from which no other nodes have descent (in the example drawn, files 106 and 107). Any earlier change will either still be reflected in one or both of these versions (so that it is seen without looking back beyond them), or has been consciously deleted or amended by one of the group, and for many purposes may be thought of as ‘taken care of’. A new change in 106, by contrast, is neglected if an attempt to create a final version looks only at 107. To neglect a proposed change could be disastrous in (for instance) a contract: one may wish to refuse it, but to omit it by accident loses its author's contribution, which may involve a key point, and also risks offending that author. To avoid this, it is wise to consider all available leaf nodes at the next stage, but identifying them in current environments has to be done by user inspection of the files.

Computer software with collaborating creators is required to have an agreed version, except where it is carefully designed as a core that supports plug-ins. Software engineers have built many ‘version control systems’, aimed to avoid even temporary conflicts. Typically, a programmer can ‘check out’ part of the code like a library book, which locks it against changes by anybody else until the part is ‘checked in’ again. The logic follows the schemes that prevent parallel processors from writing simultaneously in the same area of memory—which would be disastrous—and that work because processors follow the rules (even complicated rules) and are patient; the coder tries to minimise their idle time, but the processors do wait without complaint. Even coders, who understand the need for version control rules, have problems abiding by them.

The pattern of Drawing 1 is the natural work flow that multiple collaborators fall into. It is not easy to impose change on it. Nor is successfully imposed discipline necessarily a good thing for the text. Co-authors need to work in the times available to them, with the materials available to them up to that point. “Checking out” with locking blocks the authors from parallel use of time. Checking parts in and out separately allows some parallel effort, but incompletely so, with a troublesome interface and serious annoyance to users. (You may need to cross-check with a statement in another section, even one that is not your responsibility to edit, so you need at least “read” access. If you spot an obvious typo while reading a write-locked section, you must make a note or send a message to the person who has it open, or something equally tedious.)

No attempt to export strict control has had any success among non-coding users, except for a simpler version used in wikis: If two people try to edit the same topic simultaneously, the second gets a warning that the topic is currently being edited by another user. A topic locks automatically for some time (default one hour) when someone edits, previews or saves it. A user warned of a lock should wait until the lock is gone or contact the other user for permission to break it. Variants like TWiki (http://twiki.org) and Pm Wiki (http://www.gryla.nl/PmWiki) allow multiple simultaneous edits of the same topic, and then merges changes where possible, or else inserts marks to indicate what the text used to look like, and what each person's edits were. If in one sentence an author changes “czar” to “tsar”, with no local conflict, authors of other paragraphs might like to follow this for consistency, or reverse it, but nothing calls attention to the change.

Today's ways to relate versions are also represented by Microsoft's description (www.microsoft.com/technet/technetmag/issues/2006/10/IntoTheGroove/) of such a product:
“For unstructured data such as documents, it is possible to create a conflict. One user may stay offline for an extended period after modifying a file. During this period, other members working online may have made changes and synchronized the file several times. In this case, Office Groove 2007 warns the user that there is a conflict on the document and automatically creates a copy of the file. Each file is titled with a name identifying the member whose changes are causing a conflict. At this point, user intervention is required to reconcile the conflict, and the points of conflict should be clear.”

As soon as the document cannot be treated as a linear sequence of updates, the user “should” be able to see what happened and where. Such a method can help with the occasional failure of sequence, but would leave the situation of Drawing 1 as confusing as ever.

Clear but permissive provenance display is vital, to improve the match with the way humans think, in showing what one's collaborators have done and hence what one must work on oneself. The present invention provides a method and system to handle provenance systematically, and to use this to add value to the user's files and use of software.

### BRIEF DESCRIPTION OF THE INVENTION

The method and system here disclosed (Drawing 2) construct (and update as necessary) 200 a systematic scheme of information concerning provenance among digital objects, make all or part of this information available 210 to the user, and use it 220 to modify the effect of a user's actions. If 230 the user's immediate or subsequent actions, or another cause, create new objects within the current range of action, modify 200 the descent tree accordingly: otherwise, continue 240 responding to other input as appropriate. In a simple example, the method and system may construct a digital record corresponding to descent relationships as in Drawing 1, make the information available by a visual graph like Drawings 1, 6 or 10, or by internal display like Drawing 8 or 9, and modify the effect of a Search command by limiting the search to objects ancestral to, or with descent from, a selected object, just as a folder hierarchy allows the user to modify a search by limiting it to files in a particular folder. If the search finds a file, and 230 the user opens, modifies and saves it, the modified version is a new object with descent from the found file, and 200 is added to the descent tree.

The scheme of information constructed is a logical ‘descent tree’ containing explicit data on direct descent, analogously to the parent-child links in a family tree display, and similarly allowing multiple paths of descent from the same ancestor. It may be encoded in various ways, within the spirit of the invention. The construction 200 of it may use tracking of user actions (for example, when a file is ‘saved as’ under a new name, record this as direct descent of the new file from the older), or it may deduce descent links by comparison of the internal content of files and optionally of metadata (recorded about files without being part of them, such as the date), or by combining these methods. We disclose operational details of such construction methods, as in Drawing 4. Our preferred embodiment detects references in one digital object to material in another object, as well as ‘cut and paste’ and adaptation of such material. The descent tree may apply to all the files managed by an operating system, to all the user files, or to any convenient set of files, local or accessible via a network, which may be specified or modified by a user, or collaboratively by a set of users. The invention may be implemented as a part of an operating system, or as an application running on a user's computer or a server.

The digital objects for which a descent tree is 200 constructed and maintained may be document files, simple or layered image files in two or three dimensions, plans and designs, spreadsheets, snapshots of a wiki, contributions to a chat or whole records of chat sessions, virtual environment specifications, a web page, computer code, phone call recordings, songs, videos, music scores, and so on. They may also be objects for which content has not yet been provided, as in “the report I need to submit next Friday, using the original proposal, the clinical data report data set and the expenses spreadsheet” which would have direct descent from those three files.

The provenance information may be communicated 210 to the user by graphical means such as straight or other connecting lines between object representations (which may be file names, icons, thumbnails, complete content display where this is small enough, etc.), or by provenance indication within a display of an object's content, such as marking what other document a paragraph or other element came from, or refers to. An important use of this is where competing versions for the same element are shown within the same display, which may be either a temporary construct optimized to help the user produce a merged version, or (particularly in the case of a wiki) to display to other users the state of a dispute over content.

An important part of provenance information is often to record the originating user of an object or a version. Various means are provided for the display 210 and use of such information, in embodiments such as project flow management, collective authoring of a paper with drafts circulated or made available by a central server, chat with clarity as to what submission is being replied to, a wiki, or group development of computer code.

Among the ways that provenance information may modify 220 the effect of a user's actions are to find the set of joint descendants or ancestors of a specified object or group of objects, to delimit search to such a set, to return only originating or ‘leaf’ (not taken account of in any later object) instances of the sought element, and to identify the current leaf objects and optionally to open them in a multi-file editor, such leaf objects being often the ones most necessary to merge. It also permits the user to move a time indicator and see the state of a project, collaboration or other flow at a chosen time, the objects chosen for detailed view (optionally in a multifile display) being the leaves of the descent tree up to that time point. We disclose variants on the modifications enabled by provenance information that also invoke the level of authority possessed by a particular user, who may have privileges to declare a particular object as the current reference one, in which case it becomes the sole leaf node at that time. A user without final authority may also (notably, but not exclusively, in a wiki) withdraw a suggestion, or accept the suggestion of another user, and the contributions of users to the consensus process may be tracked.

We construct a systematic scheme of information concerning provenance among digital objects, make this information available to the user, and use it to modify the effect of user's actions. Such relationships are derived by comparison of elements in the files or by making records when creating them. This information may be displayed by a view of a descent tree, a flow diagram, or internal markup of a combined view of object content. The provenance structure enables selection of related subsets for search, constraints on search such as ‘root occurrence’ or ‘unmerged occurrences’, and selection of appropriate objects to merge or respond to. It defines the active set of objects for any chosen time, enabling a display of commonality and difference among versions at any stage of a project involving one or more collaborators, with or without one of them having final authority over the suggestions of the others. Applications include but are not limited to project flow management including bug reporting and correction, collaborative authoring (by document circulation or by wiki), enhanced chat, enhanced navigation among available objects, and retrieval of objects by following provenance pathways.

### BRIEF DESCRIPTION OF THE DRAWINGS

Drawing 1: A descent tree of multi-author edited files in typical natural workflow.

Drawing 2: Overview flow chart of the disclosed system and method.

Drawing 3: Partial match illustrated for two pairs of sentences.

Drawing 4: A flow chart of a method of descent tree reconstruction.

Drawing 5: Descent tree with possible and impossible differentiator subgraphs.

Drawing 6: A display of descent, with authors identified.

Drawing 7: Steps in the use of a descent-oriented project display.

Drawing 8: A display of multiple document versions showing provenance.

Drawing 9: A pair of chat windows with different response provenance.

Drawing 10: A service window display of descent, obliquely viewed.

Drawing 11: A pair of search matches displayed in variable-detail context.

Drawing 12: A schematic overview of a method in a computer system is shown.

Drawing 13: A schematic overview of a computer system is shown

### DETAILED DESCRIPTION

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the meaning commonly understood by one of ordinary skill in the art to which this invention belongs. It will be further understood that terms used herein should be interpreted as having a meaning consistent with their meaning in the context of this specification and the relevant art and will not be interpreted in an idealized or overly formal sense unless expressly so defined herein.

The present invention is described below with reference to block diagrams and/or flowchart illustrations of methods, apparatus (systems) and/or computer program products according to embodiments of the invention. It is understood that several blocks of the block diagrams in Drawings 2 and 4, and combinations of such blocks, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium or combination of media that can contain, store, communicate, propagate, or transport the program for use by or in connection with the instruction execution system, apparatus, or device. Such a computer-usable or computer-readable medium may be but is not limited to an electronic, magnetic, electromagnetic, optical, infrared, or semiconductor system, apparatus, device, or propagation medium. A non-exhaustive list of more specific examples of computer-readable media would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention consists in part of a method of presentation to the user of various arrangements of icons representing files or documents (in the above broad sense) or structured groupings of the same, in part of interaction methods with services enabled by these arrangements, among these but not exclusively provenance-directed search and the management of workflow, in part of the details of services to be so offered, and in part of the means by which provision of said services is achieved.

In one preferred embodiment the method presents in ‘closed’ form an icon visible in a part of the user's working space, such as the desktop, the OSX ‘dock’, the ‘quick launch bar’ of several forms of Windows™, a menu, or an open folder displayed by the operating system, said icon being by our preference similar (but not identical) to the usual icon for a folder in that environment, which may be a personal computer, an access window to a distributed system, a browser window giving access to a web service, or any graphical user interface (GUI) sufficiently analogous for our preference to be applicable. Upon the user's ‘opening’ the icon by a means standard for the environment, such as double-clicking with a mouse, the method opens a window which may appear empty or (as a result of previous interactions with the same icon) contain icons for files available to the user for reading, editing, listening, viewing or other forms of passive or interactive display, with means for selecting subsets of files and for dragging files in and out. When a folder icon is dragged into such a window, so recursively are the files and folders it ‘contains’, becoming part of the ‘current universe’ of files currently accessible through that window.

In an alternative embodiment, the method of the present invention is made available as a service that may be invoked by a user application, either by default or by a user command such as clicking on a menu item, and either embodied in code that is part of the code for said application or (in our preferred embodiment) as a body of code which may be invoked by more than one such application by the use of standardized commands, adding preferences appropriate to the application. (For example, a design software suite could invoke it with a restriction to files of the type it creates and edits, and provide element matching specialized for such files, that would be called by the provenance reconstruction functions disclosed below.) The latter embodiment may also optionally be combined with the window embodiment introduced above, which the user may invoke via the OS without opening a separate application.

Any of the above methods shows items in a window, whether perceived by the user as an independent window, or a subwindow of an application. We discuss below the manner in which its contents are to be displayed, showing provenance and workflow. First, however, we describe means by which provenance and flow can be determined and categorized in the computer.

A key step, if provenance has not already been mapped, is to recognize elements in common between files, that are overwhelmingly unlikely to have arisen multiply by chance rather than inheritance among files. We discuss this in greatest detail for text files, but analogous recognition means for image files, sound files, video, musical scores, virtual environment files, etc., will be clear to those skilled in the respective arts, and their use in the manner described below is within the spirit of the present invention.

### Assessment of Provenance

A key element of one aspect of the present invention is to associate with each file in the current universe the fact (noted at the time, or deduced a posteriori) that its creation drew upon other files, wherever these can be identified. (In some cases they cannot be identified, either because the file is wholly new, or because its precursors are not known or not in the current universe.) Various means are provided for said a posteriori deduction, based on common elements, but other means may be used within the spirit of the present invention.

In the case of text files or other sequential documents such as computer programs, files recording the parameters for three-dimensional models (such as vertex coordinates, spline parameters, etc.) we may quantify commonality of elements by string comparison algorithms, with our preferred embodiment using or adapting those developed for comparison of DNA sequences. The simple tests used in most string searches, whether across the web or within a word processor, look for an exact match. A search in the present document for “pixies” would find only the occurrence in this sentence, not the two “pixels” above. An exact match for a sentence containing the mistyped version could not be the corresponding sentence in a later, corrected version: similarly, a systematic Americanization of UK spelling creates a new version where few sentences match their sources exactly. Such sharpness is not acceptable in bioinformatics, as mutations, substitutions, transpositions and so on are central to the science. Accordingly, algorithms have been developed that are sensitive to approximate matches, beginning with S Needleman and C Wunsch, A general method applicable to the search for similarities in the amino acid sequence of two proteins, J. Molec. Biol. 48(3): 443-53 (1970), and the variant of their algorithm described by T F Smith and M S Waterman, Identification of Common Molecular Subsequences, J. Molec. Biol., 147:195197 (1981). (The latter is more sensitive to local alignment without requiring a global match.) However, efficient string comparison can also exploit the easily parsed hierarchical structure of texts, almost always including at least sentences and paragraphs, and often chapters, sections, subsections, etc., at multiple levels. No such straightforward structure has been identified in chromosomes—though there is a suspicion that some of the ‘junk DNA’ has a somewhat analogous organisational function—so that the standard algorithms of bioinformatics are not arranged to exploit it and find not only matching substrings of the text, but matches of paragraphs, sections, etc., as such. Various refinements of these algorithms to do so will be evident to one skilled in the art.

Drawing 3 diagrams the coding of differences and matchings at the level of a pair of sentences, considered as strings of characters, in the form of the match as recognised by an algorithm such as Smith-Waterman. For display convenience, and because the software can do the same, we have broken it into the matching 301 of a first sentence and the matching 302 of a second. The slanting lines 310 show the correspondence of substrings, and the vertical lines 320 the gaps to which no part of the other string corresponds. Even with penalties for gaps and interchanges (and optionally for mismatch of upper and lower case letters), any scoring system gives this a far higher match value than chance. A semantic system able to recognise a proximity in sense between “we have known x” and “x has been known” would raise the score yet higher, and its use would be within the spirit of the present invention, but remains too computationally costly for our preferred first embodiment. Pure string-matching algorithms suffice for our present use: preferably adapted to hierarchies of sentence, paragraph, etc., but much can be done using directly the flat matching tools which have been highly optimised for biochemical work.

A preliminary comparison can exploit hierarchy for efficiency, since for example a sentence or paragraph in file A which perfectly matches a sentence or paragraph in file B must match it, in particular, at the ends. Consequently, a search for perfect or for large-block matches can discard many candidates fast, by the failure to match at the start or end, decreasing the time taken to find all the perfect matches. To find these is, in many cases of related genomes or of drafts of the same document, to find a large fraction of the overall matching structure. Less effort is needed to find the remaining imperfect matches. However, this is an issue of algorithmic performance, since the overall matching description sought is the same in either case: the present invention exploits only the fact that such a description can be found (and found fast enough to be useful), together with means of exploiting this description. A preferred first embodiment is thus to adapt the highly optimized forms already achieved for the algorithms current in molecular biology, without changes that could sacrifice that optimization. Later embodiments of the invention may exploit more fully the available structure.

A far-reaching embodiment of the present invention would maintain a record of the renaming of P9070009.jpg, by various means. If the user opens it as P9070009.jpg and saves it as FredEatingSoup.jpg, the image software could cooperate with the present invention by recording this. (Such cooperation could extend to recording a ‘Save As’ after changes like cropping, changing resolution or file format, adjusting the colors or reducing them to black and white or to sepia, etc.) The operating system could co-operate by recording a simple renaming of a closed file. However, in the absence of such support an embodiment of the present invention can at least test for binary matching those files whose extensions declare them as similarly formatted images. Inclusion of any more subtle image-matching algorithm improves this, but even a plain digital correspondence test enables assistance to the user, provided that P9070009.jpg is still separately available for comparison. This illustrates a general feature of the provenance approach: wherever possible, save versions, rather than overwrite them. Independently of the present invention, the falling cost of long-term memory encourages the approach “Expanding Storage: Everything Must Stay!” (http://www.computerworld.com/action/article.do?command=printArticleBasic&articleId=300982) and the present invention is one of many advances made possible by this trend. Where an object is simply renamed—making it seem excessive to store it under each name—the present invention includes the use of a record (if made, as we prefer) of the fact that the renaming occurred. Similarly, if an identical copy is made and stored (optionally under the same name in a different folder, or necessarily a modified name if in the same folder), our preferred embodiment of the present invention includes the making of a systematic and permanent record of the fact for later reference, though later comparison could also recover the identity.

Where a file A drew upon a file B, or upon a file that drew upon B, and so on recursively, we say that A ‘has descent from’ B. This relation may reflect the fact that A was created by editing a copy of B, by incorporating material reproduced from B (altered or otherwise), by explicit reference to B, by indirect allusion to B (where the art permits the algorithmic detection of such allusion, or where the fact of it is entered by a human user), by inclusion of a hyperlink to B, or by other such manner as will be evident to one skilled in the art. All such factors are called ‘traces’ of B. Material from B that is incorporated in A may consist of one or more segments of text, a melody or rhythmic structure or several of such, a geometric specification of a shape, a specification of a game, or of analogous matter that will be evident to one skilled in the art. Where material from B is incorporated in A and edited or altered, the editing might be by a text editor, image editor, computer-aided design (CAD) program, music editor, molecular simulation program, database manipulation tool, or other such software as will be evident to one skilled in the art.

A file C is a ‘provenance intermediary’ between A and B if C has descent from A, and every trace of B that is found in A (whether reproduced from B, a reference, allusion, a hyperlink, etc.) is found also in C. Where no known provenance intermediary exists between A and B, we say that A has ‘direct descent’ from B or is a ‘child of B, which is a ‘parent of’ A. As an example, if the content of three increasingly recent text files P, Q and R consists of the strings

“In my time I have married Harry and Maria”, (P)

“In my time I have married George and Maria”, (Q)

“In my time I have married Harry, George and Maria”, (R)

respectively, and no other files are in the current universe, then we take Q to have descent from P by the traces “In my time I have married” and “and Maria”, R to have descent from P by the traces “In my time I have married Harry” and “and Maria”, and R to have descent from Q by the traces “In my time I have married” and “George and Maria”. All these are direct. However, in the case of

“In my time I have married Helen and Maria”, (P′)

“In my time I have married George and Maria”, (Q′)

“In my time I have married Harry, George and Maria”, (R′)

every trace of P′ found in R′ is also in Q′, so that Q′ is a provenance intermediary between P′ and R′. Note that this ternary relation is defined strictly in terms of evidence internal to the files. The ‘posterity’ of a file consists of all its children, their children, and so on recursively, while its ‘ancestry’ is recursively the parents.

Such direct descent data are considered to form a collective descent structure, an acyclic directed graph whose nodes correspond to the files and whose edges correspond to direct descent between them. This is referred to as a ‘descent tree’ by analogy with the ‘family tree’ of genealogy. (This is wider than the typical usage of ‘tree’ in graph theory, where connection is by unique pathways. If your parents were first cousins, you have at most six great-grandparents, with one pair related to you by two paths. Note also that we do not require the graph to be connected: if some documents on your computer are versions of a business plan, while others are drafts of a novel, it is typical that no file in one set adapts or quotes from a file in the other.) An embodiment of this aspect of the present invention may use a variety of data structures. Among these are a relational database in which is stored a unique reference identity (ID) for each file, associating with this ID the OS data by which the file may be accessed, a set of IDs of files from which the corresponding file has provenance, and a set of IDs of files having provenance from it. (Since the latter can be reconstructed from the former, it is not mandatory to store it, but our preference is to do so for speed of retrieval.) An alternative embodiment is to store for each file an ‘object’ with a structure specified by a ‘class’, containing pointers to file access data and to the objects corresponding to files related by provenance. Yet another embodiment is to store a matrix whose entry Rᵢⱼ takes one value if file i has direct descent from file j, a different value if file j has direct descent from file i, and a third value otherwise. Other descent tree structure realizations will be evident to one skilled in the art, within the spirit of the present invention. The preferred choice in a particular embodiment depends on the computing environment, and the maximum expected size of the current universe to be handled. If the present invention is integrated with an OS, the preferred embodiment is to embed the provenance information in the scheme used by the use to record data that are currently stored about files, such as date, disk location, and folder membership.

The same descent tree structure may be used for all files within the range of an embodiment, such as all files on the hard disk or disks of the user's computer, for those in a folder of the OS, optionally including its subfolders, for the current set of files associated temporarily with a display window, or for other sets of files that will be evident to one skilled in the art. Typically the descent tree for a disk, computer or server, or all or part of a folder hierarchy would be recorded in permanent storage and frequently updated there, while for a temporary display grouping it may exist only in dynamic memory, preferably associated with a window. However, if such a window is closed but not removed, so that its icon remains visible for re-opening, we prefer to record its descent tree for re-use, rather than rebuild it when called for.

Even where provenance data exist for the full set of files in a user's computing environment, the current universe U needs its own tree for the user interactions disclosed below. It is then simply a sub-tree E (still without connotations of connectedness or unique pathways between nodes) of the descent tree E for the whole environment. Constructing it requires locating for each file F in U the corresponding node of E, checking which of the files in E that are related to F by provenance data in E are also in U, and copying the provenance data for these into Σ. If in E the file C is a provenance intermediary between A and B, which are in U while C is not, in Σ the files A and B may be marked as related by direct descent. Alternatively, the scheme of putting files into a window may be extended. For any subset X of the files in the user's computing environment, define the ‘provenance hull’ H(X) of X to contain every file that either is itself in X, or is a provenance intermediary in E between two files in X. (The provenance hull of H(X) is then H(X) itself, which is thus ‘closed under provenance’.) Instead of permitting an arbitrary set of icons to be included in U, we automatically add also all files in the provenance hull of the set of files that have been inserted by any means into U.

In our preferred embodiment, provenance information is maintained at the OS level, and compliant applications add functionality to the ‘Save As . . . ’ command. This reports when a file opened as A, perhaps modified, is saved with a name B. The descent of B from A is then automatically stored in the environment descent tree E. In standard current art there is an OS-level ‘cut and paste’ function which copies text and other material from the displays of very different applications (browsers, editors, folder windows, etc.) and makes the copy available for insertion in other applications that accept keyboard input. This should be modified to record the identity of the source file, and make it available to the accepting application, which should register the source file as part of the descent of any saved file containing the pasted material. In the simplest version this would simply label the currently open file as descended in part from the source file, and apply that information to any file adapted and saved from the currently open file. In a preferred version it would continue to track the pasted material as the file is edited, and delete the descent information if all parts of the pasted material (including those moved and re-copied within the file) are later deleted. However, achieving these preferences requires wide co-operation from the creators of operating systems and applications, so we do not anticipate that this will be available in the first embodiment.

Even where a system-wide descent tree is maintained in this way, this does not automatically detect descent of a file A from a file B (as above disclosed) “by explicit reference to B, by indirect allusion to B (where the art permits the algorithmic detection of such allusion, or where the fact of it is entered by a human user), by inclusion of a hyperlink to B,” or other such means, so that direct inspection of file contents by the software supporting the embodiment is appropriate. Detecting a hyperlink is simple, so our preferred embodiments would include this early. The other features, which are desirable but not essential to the present invention, depend on the inclusion of sophisticated natural language processing (NLP), as and when it becomes available.

Where an environment-wide descent tree is not chosen, or does not have the above co-operation from the ‘Save As . . . ’ and cut-and-paste mechanisms, the invention requires substantially more deduction from evidence internal to files. This may still apply to all files in an environment (analogously to the application Google Desktop doing its own indexing of all a Windows user's files, apart from any search indexing that Windows may do), or it may apply to a subset, such as the current universe U of the displayed window. For clarity we discuss it for the latter case, since any person skilled in the art can equally apply the described methods to a larger set. We discuss various methods for descent tree construction.

Where the user has saved files one by one at different times; these times give a creation sequence for the files. However, if in Drawing 1 this is left to right order, the creation sequence is

100→101→102→103→104→105→106→107,

quite different from (and less informative than) the descent tree shown by the arrows in that drawing, which is what we wish to reconstruct. The latter is our primary case of interest, with a creation sequence available, but it may also occur that a user moves a set of files from another computer, upon which event the OS often saves them with the arrival date, the strict dates of creation and most recent modification not necessarily being transmitted with a file. Some applications attach metadata to files that record the original creation date and latest modification date, but not all do so, and the data are often in error (we have created Word files and seen them credited to the year 1914). It is thus a significant aspect of the present invention, though not required in all embodiments, to reconstruct a descent tree with a minimum of external data.

There can be no universal, invariably correct solution to such reconstruction, as simple examples illustrate. For example, if we have two undated text files, one containing only the words “The President is a cook” and the other only “The President is not a cook”, the word “not” may have been either added to one or deleted from the other. However, with a larger set of files and more differences between them, heuristic methods can construct a descent tree accurate enough to be useful. We disclose below a number of such methods. In general they work better with large files differing in many places than with small files that are near identical, because each ‘differentiator’ (feature found in some but not all of the files) adds a constraint on what descent tree is possible. With enough constraints, and a preference for the simplest graph that satisfies them, the unique answer is usually a match for the historically correct descent tree.

A user creating a new version of a document takes a previous one, and makes deletions, substitutions, and insertions of matter that is either new or from a different previous version. Without time order, where x is in version A but not in B we cannot start by assuming that it was deleted from B to give A, or added to A to give B, so we call this kind of difference a “deletion|insertion” or DI, and a substitution an S. The most precise comparisons, such as the DNA-matching Smith-Waterman algorithm, can identify a difference within a context of matching material: pxq versus pq for a DI, pxq versus pyq for a substitution. We call these ‘contexted differences’. An extension of this uses ‘hierarchical differences’, where a location is determined for each element in a hierarchical frame such as ‘chapter, section, paragraph, sentence, clause’, the matching of two files begins with finding a best fit between their hierarchies (as graphs with headings attached to the higher nodes), and a perfect match of elements requires correspondence between their locations, or is made stronger thereby. (Partial matches are important in tracking an element through different versions, whether the incompleteness of a match involves small changes or a move within the file.) ‘Hierarchical contexted differences’ combine this with testing for matched material before and after the differing string. For file types with other hierarchies, such as layered images, or virtual environments where objects move with their ‘parents’, the analogous contexted and hierarchical matching will be evident to one skilled in the art.

Remarkably, we find that for realistic document sets reconstruction of the descent graph requires merely a knowledge of elements that occur anywhere in the text, regardless of location. This treats ‘pxq versus pyq’ like a deletion|insertion of x combined with the reverse deletion|insertion somewhere else of y (we call these ‘context-free differences’), but it incurs much less computational overhead to treat differences. Moved elements contribute fully.

For purposes of descent tree reconstruction, we treat two files with identical sets of differentiators as a single file. Where differentiators are based on context free elements, this conflates files that do differ but only by a reordering of elements. Where this might be a problem, context-linked differentiators should be used.

We define a ‘shared element’ for documents as a maximal connected string of text symbols (optionally including markers for font, italicization, etc., and optionally reflecting hierarchical structure) that occurs (anywhere) as a substring of all of the documents Vᵢ in the current universe U. Shared elements are of no help in reconstruction, and are dropped from the analysis. For each Vᵢ the ‘difference set’ Dᵢ is the complement in Vᵢ of the shared elements it contains, considered as not connected across gaps. A ‘string-based differentiator’ δ is a maximal connected string that occurs in at least one Dᵢ: if contained in every Dᵢ it would be contained in a shared element, so there is a proper subset Y_{δ} of U consisting of those Vᵢ that contain δ. We refer to this as the ‘differentiator set’ corresponding to δ.

An alternative to maximal strings that is convenient in practice is to parse each Vᵢ into sentences, by such sentence-break criteria as “stop followed by whitespace followed by capital letter”, “end of paragraph”, etc., and to take any sentence that occurs in some but not all Vᵢ as a ‘sentence-based differentiator’.

If the files (or some of them) are image files, manipulated by the user using PhotoShop™, PaintShopPro™, the Gimp or a similar application, other kinds of shared element and differentiatior are needed. An embodiment of the present invention covering these files must be able to recognize resemblance between images (preferably even where these have been rotated, filtered, spatially distorted, changed in colour values, etc., using the tools such applications provide), detect that one layer of image file A corresponds to another layer of image file B, detect that one layer or whole image in A corresponds to merging two or more layers in B, and recognize matches across different file types. This may require some substantial programming: for example, PhotoShop™ can open a PostScript file, which may hold include data but more generally has instructions to insert (for instance) curves mathematically specified as to shape, thickness, color, and dash style. Since the PostScript standard is only a quarter century old, such a file can be inserted or read by only the most recent versions of Word, and therefore a user often saves a version in jpeg or other purely-image format, which can be used in a Microsoft Office context. It is thus desirable for an embodiment of the present invention, if it is to be used with image files, to include a PostScript interpreter to allow matching of a set of instructions to the resulting arrangement of pixels. Means of doing this will be evident to one skilled in the art, but our concern here is with the exploitation of similarity elements (and differentiators educed therefrom), once recognized, rather than with reciting or adding to the art of matching. Similarly specialized matching tools are needed to apply the present invention to audio or video files, music scores, CAD files, mine or well data, 3D scans, virtual environments, city plans and other user files, as will be clear to those skilled in the art, but the present invention addresses the use of the similarity elements identified by such matching tools, not their functioning. For exemplary purposes we continue to illustrate this with the case of document files, to which the invention is applied in our preferred first embodiment, but this is not intended to limit the scope of the application of the present invention.

The assumption in what follows is that each differentiator, in the form where we find it, originated exactly once. A one-word insertion, deletion or substitution could often be made as a correction by several authors independently, so string-based differentiators should exceed a length threshold. We assume that identical sentences do not arise by accident, and that an element deleted in a descent edge cannot reappear without descent from a version containing it. For example: if the earliest file X in U={X, Y, Z} contains a differentiator A that is not in Y, then Z cannot contain A except by direct descent from X. Thus (X→Y, Z), meaning that Y has descent from X and Z has descent from neither, and (X♯Z→Y), meaning that Y has descent from X via Z are compatible with this distribution of A, but (X→Y→Z) is not. Which of the former two holds true can be decided by whether Z contains A. If dates are unknown but A is in Z and X only, while a differentiator B is in Y and X only, then (Z-X-Y) with any assignment of directions is a possible sub-tree of the descent tree. If there is a C in both Y and Z that is not in X there must also exist a direct descent relation between Y and Z; if there is no such C, we have no evidence of descent other than via X, and by a principle of parsimony deduce that no such descent is present.

The distribution of each differentiator thus constrains the possible set of direct descent links. In the presence of enough links, there is often a unique descent tree that satisfies them; if it is not unique, it is reasonable to seek the smallest. When we are seeking a directed tree even a little information (like X being the earliest, in the example above) can greatly reduce the possibilities. If complete date information is available, or just the time sequence of the files, it is generally enough to identify for each differentiator the first and second files in which it occurs. When the second was created, the first was the only source for that differentiator, so the second must have direct descent from it. (The third may have taken it from either the first or second, so the differentiator's presence does not yield specific descent information without combination with other facts.) This single principle usually suffices to recover all direct descent links, and reconstruct the descent tree. Other heuristics may be added in the fully-dated context, but we disclose here a reconstruction of an undirected graph from undated files, followed by means of recovery of the directions that make it a descent tree. This robustly covers the full-dated case, where we simply direct each link from the earlier file to the later.

Many algorithms are possible within the spirit of the present invention, but for exemplary purposes we describe one based on a particular similarity measure, which quantifies matching sentences and ignores sentence order and hence transpositions. Alternative similarity measures, as exemplified above, could be used, as will be evident to one skilled in the art. The disclosure below addresses primarily the situation typical of a set of versions of a single document, where there is a (not necessarily known) first draft, and while a much later draft may have no single sentence in common with that first draft, it can be connected to it by a chain of intermediate drafts, each having at least a minimum number of similarity elements in common with the next. We call this a ‘differentiator chain’. If there are files that are not connected by any such chain—as often occurs, for instance, if the set includes all the documents on a particular user's hard disk—we refer to the cluster of files that can be reached by such chains from a particular file A as the ‘connected component’ of A. The same cluster is also the connected component of any other file it contains, so the whole set splits into such components. Where the set is not connected, we apply the method below to each component separately. The flow diagrammed in Drawing 4 is given as an exemplary embodiment of the method: the operations described could be performed in a modified order evident to one skilled in the art, within the spirit of the present invention.

If A and B have more differentiators in common than C and D have, we say that A and B are ‘more similar’ than C and D. This measure may simply use the number of differentiators, but we currently prefer to weight the contribution of each differentiator by its length. The algorithm assumes

1) Each document contains a unique proper subset of the set Σ of differentiators.

2) The files Y_{δ} containing any specific differentiator δ, together with the edges of the descent graph Δ between members of Y_{δ} form a connected sub-graph of Δ.

3) If a document X is more similar to a document Y than to any other, there is a descent graph edge between them.

We create 300 a graph structure G with a node for each file in the set U, and initially no links, and populate it as follows.

### Step 1: Create Similarity and Dissimilarity Matrices and Differentiator Sets.

Set up 301 a lookup table T, and two N×N matrices ψ and φ, where N is the number of files. Read 310 the N documents one by one, assigning an integer ID i to each, initializing to 0 its total length |i| and its similarity value to all other documents. Examine it 311 sentence by sentence, computing character count (or, optionally, word count) |A| of each sentence A, and adding |A| to |i|. If 315 the sentence A has not been seen before, put it into the key column of table T, and insert the document's ID as the first element of a list created as a corresponding value S_{A}. If 316 it is already in T, append i to the list S_{A}, and 317 for each documents already in the set S_{A} increase by |A| the similarity value of i with i. For example: consider a current universe U={X, Y}, given the IDs 0 and 1. As the document X is read, put into L each sentence found in it, with 0 in its set. Next, read each sentence A in document Y: if A occurs in X, append 1 to its set, which already contains 0. Otherwise, put A in L, with 1 alone in its set. When this is complete, if A is in both X and Y then its entry (S_{iA}={0,1}) contains the two document IDs 0 and 1. Increase 319 the similarity score between them by |A|. This procedure, applied to all sentences in all documents constructs the symmetric similarity matrix Ψ. If Ψᵢⱼ<Ψₖₗ, we say that k and l are ‘more distant’ than i and j. Where convenient, we may write Ψᵢⱼ also as Ψ(i,j). When 312 there is no next sentence, store the final value of |i| and return to the step of finding a next file, if any.

Next, with |i| as the total length of the document with ID i, fill 320 the asymmetric dissimilarity matrix Φ, where Φᵢⱼ=|i|−Ψᵢⱼ/and Φⱼᵢ=|j|−Ψᵢⱼ, respectively the addition and deletion values of document i with respect to documents. For example: consider an i^{th} document of length 300 characters and a j^{th} document of 350 characters. If their similarity value is 200 units, then Φᵢⱼ=150 and Φⱼᵢ=100.

The similarity matrix entry Ψᵢⱼ=Ψᵢⱼ tells us how much text was retained in any descent process between files i and j, whereas φᵢⱼ tells us how much was discarded in any putative descent from i to j, ignoring transpositions. For example, consider documents i containing only the string “ABC” of sentences and j with string “ABDF”. We treat the sentence strings as sets, and give {i,j} the similarity value |A|+|B|. The dissimilarity values are Φᵢⱼ=|C|, with only C lost from i, and Φⱼᵢ=|D|+|F|, with D and F lost from j.

### Step 2: Sort the Sets by Cardinality

Extract 330 a list L of the sets occurring in the table T, suppressing repetitions and discarding singletons. (Two sentences that both occur in exactly the same set of files are no more informative A about connectivity than one—and their combined length is already a weight in relevant similarity entries. A sentence occurring in exactly one document has no evidential value on descent.) Sort L by element count. For example, if the sets in T are {A,C},{B,C,E,J},{A,C},{B},{A,C,E}, they are sorted into L as {A,C},{A,C,E},{B,C,E,J}, with the set {A,C} once and the set {B} discarded.

### Step 3: Connect the Elements of Each Set by Centrality

For each set Y in the list L, create 332 an identical new set Y, and initialize a similarity comparison σ=0. Then iteratively
a) Find 333 for each i in Y its similarity σ(i) to the whole set Y (defined as the sum of the similarities Ψᵢⱼ with j also in Y) as the smallest 340 of the similarities Ψᵢⱼ with j also in Y, or by any function of the ψᵢⱼ that gives a low value for those files that can be considered as atypical of the set.
b) Retain 341 the i in Y for which σ(i) is least: call it i.
c) Order 350 the i in Y by Ψᵢⱼ values (similarity to i) with the least first.
d) For each j 360 Y in the new order, create 361 a link in G (unless it already exists) to the k for which ψₖⱼ is greatest. If more than one k give this greatest Ψₖⱼ value, choose among them the k for which φₖⱼ is least.
e) Remove 362 j from Y.
f) If there is still an element in Y, return to (d).

When 363 this is complete, the set of links is necessarily a connected acyclic graph with nodes U, since the construction prevents cycles and it has one fewer links than nodes. Add these links to G, and repeat 331 for the next set Y in L (which may add links that create cycles in G).

When this process is complete, the graph G satisfies conditions 1 to 3 above, and this is our (undirected) candidate for the descent tree.

Many alternate embodiments of this construction (create a ‘spanning tree’ for each Y_{δ}, with a bias to linking nodes that are more similar or less dissimilar) will be evident to one skilled in the art, within the spirit of the present invention. For example, an adaptation of Kruskal's minimal spanning tree algorithm replacing steps 2 and 3 above, with identical results on test sets, is as follows.

For each differentiator set Y_{δ}0 set, we create a new list a of 4-tuples [i,j,Ψᵢⱼ,Φᵢⱼ] each of which contains four elements: the identities of a pair of documents in the set, and their similarity and dissimilarity values. For instance, if Y_{δ}=[0,2,4], so that δ exists in documents 0, 2 and 4, the corresponding list a may be
{[0,2,200,350], [0,4,300,200], [2,4,220,150]}
   for the three pairs [0,2], [0,4] and [2,4] with their similarity and dissimilarity values. Sort the list in descending order on the basis of the similarity values. In case of a tie, resolve it using the smaller dissimilarity value first. In the example, a becomes
{[[0,4,300,200], [2,4,220,150], 0,2,200,350]}

Initialize to zero a flag fᵢ for each document i. Traverse a as follows:
1. For every 4-tuple [i,j,Ψᵢⱼ,Φᵢⱼ] if fᵢ and fⱼ are both zero, assign a previously unused number to them and create an edge between i and j.
2. If exactly one of fᵢ and fⱼ is zero, set both to the non-zero value, link i and j.
3. If 0≠fᵢ≠fⱼ≠0, reset to min(fᵢ,fⱼ) every fₖ where k is in Y_{δ} and fₖ=max(fᵢ,fⱼ).
4. Return to (1) with the next 4-tuple in a unless |Y_{δ}|−1 links have been generated, N being the number of documents in the list.

(In the example, the links generated would be 0-4 and 2-4.)

Repeating this for all differentiators creates the undirected graph G.

To complete the descent tree construction, we must assign a direction of descent to each link. In the not uncommon case of G being a simple chain
X₁-X₂- . . . -X_{N-1}-X_{N}
   the structure captured by the table T is compatible with either X₁ or X_{N} being the earliest version, and the other being the latest. If an intermediate Xᵢ has a differentiator δ that occurs also in Xᵢ₋₁ and Xᵢ₊₁, we can rule out the possibility that Xᵢ is a leaf node, as the differentiator subgraph for δ would then have two roots. It is logically possible that such an Xᵢ is the root of the whole graph, with two descent histories beginning there and ending in X₁ and X_{N} without ever interacting, but heuristically we ignore this possibility, assuming that one of X₁ and X_{N} is the root and the other the end. It is usually possible to decide which is which on semantic grounds: for example suppose that we have a subsequence of files containing the sentence sequences

U

| | |
|---|---|
| The nation is in turmoil. | A |
| The Premier is in the hands of the Army. | D |

V

| | |
|---|---|
| The nation is in turmoil. | A |
| (And so, Prince Qor is King.) | C |
| The Premier is in the hands of the Army. | D |

X

| | |
|---|---|
| The nation is in turmoil. | A |
| The Queen is dead. | B |
| (And so, Prince Qor is King.) | C |
| The Premier is in the hands of the Army. | D |

Y

| | |
|---|---|
| The nation is in turmoil. | A |
| The Queen is dead. | B |
| The Premier is in the hands of the Army. | D |

Sentence C occurs in all the files between V and X, and only in those files. Either V has the first occurrence and X the last, or vice versa. It makes no sense that a user working on U would add C between A and D, to produce V, but it is plausible that it could be added in Y to give X. Somewhere between X and V, sentence B is deleted, but only in file V does someone notice that this has made nonsense of C; and therefore deletes C also. (Similar patterns happen in revising computer code, where a comment is updated several steps after it becomes obsolete, or a function is removed after the code that once called it.) The order of the whole chain is thus . . . Y, X, . . . V, U . . . . A single such instance settles the entire order.

It is within the spirit of the present invention to use natural language processing algorithms to automate such reasoning, where available, sufficiently effective, and not too costly in processing time. However, in our current preferred embodiment we prefer to recognize the ambiguity and ask the user to resolve it, for example by choosing which of the two end files was first. This is still a minor interruption of the user's work, compared to working out the whole sequence by direct inspection, and maintains the utility of the descent mapping service. More generally, we find that it is often possible to identify unambiguously the leaf nodes of a complex descent even where the assumptions described here are consistent with more than one candidate for its roots. The leaf nodes are often ‘action items’ needing to be reconciled, while the early history is less important, but where a full reconstruction is needed the system can offer the small set of root candidates for the user's human judgment as to which is or are the overall original document(s): with these data, the remaining ambiguities can speedily be resolved, for example by the assumption that of two linked nodes, the one less similar to the root is descended for the one more similar. As an alternative embodiment of the present invention, the system may—before attempting to assign directions—ask the user to identify a root node or nodes. Ordering by dissimilarity to the root or roots can then replace much of the computation described below.

Where the descent is more complex, as in Drawing 1, automatic direction finding is both more needed (to help the user cope with complexity), and more practical.

In Drawing 5, the grouping 510 of occurrences of a differentiator (in the files shown joined by dashed lines) is typical of real events: the differentiator occurs in a first draft 500, and is copied into drafts 501 and 502, but the author creating 503 deletes or otherwise improves it. The author of 504 (working only from 501 and 502) also leaves it, but the author of 505 prefers the change from 503, or a new variant, rather than letting it persist from 502 or 503. The authors of 506 and 507 make a similar choice, and the differentiator does not persist past 504.

By contrast, given the descent relationships shown, the group 520 is vanishingly unlikely. The same differentiator would have to be inserted twice, independently, by the authors of 501 and 503. Conversely, if a differentiator is found in exactly these three files, it constitutes strong evidence against the directed graph shown by the arrows. If we assume that the links are correct, as undirected graph edges, it is evidence against the directions shown.

More generally, define a ‘leaf’ of a directed graph F as a node with links only to it, and a ‘root’ as a node with links only from it. If Y is a subset of the nodes of Γ, the subgraph Y_{Γ} of Γ ‘on’ Y has the members of Y as its nodes, and as links all the links of Γ that have both ends in Y. We call a node y in Y a leaf or root of Y, relative to Γ, if it is respectively a leaf or root of Y_{Γ}. In particular, a leaf or root of Γ is necessarily also a leaf or root (relative to Γ) of any set Y of nodes that contains it. We take as an axiom that for no differentiator δ does the set Y_{δ} have more than one root. (More exactly, we take it as a criterion on our algorithm for finding matches and differentiators that it must not tag anything as a differentiator unless its chance of arising twice independently in a set of versions is negligible.) It follows that no leaf node l of such a set Y_{δ} can separate the subgraph on Y_{δ} of the descent tree, in the sense that without the node l and the links joining it to other nodes, what is left of the subgraph is not connected: since each component of what is left must have at least one root, these would be multiple roots for Y_{δ}. (For instance, the leaf node 505 of the subgraph 520 separates it into the two single-node fragments 501 and 503, inconsistently with the subgraph 520 being Y_{δ} for any δ.) As a corollary, no node that separates any Y_{δ} can be a leaf node for the descent tree as a whole.

The next part of our method is thus to identify 470 every node in G that separates Y_{δ} for any differentiator δ: for efficiency, we include this in the loop 431 already described. The remaining nodes with indices i₁, i₂, . . . iₘ, after removing 471 those found for each Y, are candidate leaf nodes for the descent tree. (Normally m is small.) For a general node j, compute 480 its similarity to this set of nodes as Ψ(j)=maximum(ψ(iᵢ,j), . . . , ψ(iₘ,j)), and its difference as Φ(j)=minimum(φ(i₁,j), . . . , φ(iₘ,j)). (Many alternatives to these formulae will be evident to one skilled in the art, within the spirit of the present invention.) For every link in the undirected graph G, direct it 481 from the end with lower Ψ to the end with higher Ψ; if there is a tie, direct it from the end with higher Φ to the end with lower Φ. This makes G into a directed graph.

As a consistency check, test that our axiom holds, so that for each differentiator δ the set Y_{δ} has exactly one root. In any case that it fails (as for a chain it must), rank the candidate leaf nodes i₁, i₂, . . . iₘ by their similarity to the whole set U, similarly to the definition in step 3a above. Discard from the list of candidate leaf nodes the candidate most similar to U, and repeat the direction assignment with the restricted set. If the axiom holds, give the resulting directed graph as the result. If it fails, restore the discarded candidate, and repeat. If all single-candidate deletions fail, test deletions of pairs of candidates, again deleting the more central candidates first; if this fails, test deletion of triples, and so on, until the tests are for single leaf node candidates. If all of these tests fail, return the structure with fewest violations of the axiom.

When a structure is returned, test whether each Y_{δ} has a single leaf, as well as a single root: this always holds for a simple sequential chain, and occasionally for more complex cases. If it holds, the completely reversed graph is equally a fit with the differentiator subset data. In our current preferred embodiment, we ask the user to resolve this ambiguity. A later embodiment may solve it by semantic analysis, as in the example above of the chain Y, X, . . . , V, U.

As noted above, the method is partly heuristic, with no mathematical guarantee of correctness. Indeed, minimal examples where it fails can easily be constructed, but failure examples from user-edited files with a typical number of changes are extremely hard to find. Where the result is false to historical fact, it nevertheless gives a clear enough reconstruction of the history to serve the purposes of navigation, synthesis and other services discussed below.

Note that the axiom of a single root applies to each differentiator set, but not necessarily to the whole descent tree, even if it is connected. The current universe might contain a first draft of a business plan, the first draft of a white paper on a specific product, and the descendants of each. If at some stage the abstract of the white paper is cut and pasted into a late draft of the plan, the joint set of descendants is connected, but has two roots. The method assumes the axiom only for differentiator sets.

### Arrangement by Provenance

The core of the aspect of the present invention that exploits and displays provenance information is that historical links between files are systematically displayed to the user. Our preferred embodiment of this is by means of a service window, but the methods described below may also be used within any local or web-based application, for either individual or collaborative use, such as but not limited to a word processor, image manipulator, music composition system, video editor, CAD system or molecular simulator, which permits the user to create, load, modify and save files.

The descent tree is displayed in whole or part to the user, in a graphical display that shows by connecting lines or otherwise the provenance relations, and identifies individual files. One embodiment shows the descent tree 600 as in Drawing 6, in a window 601, divided into columns 610 which are labeled 611, 612, 613, 614, 615 by identities of individual collaborators, using names, user identities, images or such other means as may be substituted by one skilled in the art. Each icon 620, 630 or 631 representing a file appears in the columns 610 according to the associated individual, who may be the recorded originator of the file according to metadata within the file, the user associated with the file by the software embodying the present invention, who may be the user recorded as having saved the file (either by said software monitoring an application, or by a compliant application), or in the case of the embodiment running on a server accessible to multiple users, the user who uploaded the file to said server. Names such as OS filenames may be shown next to the files, but in our preferred embodiment a single project name 631 is shown for the project as a whole, with individual filenames accessible (e.g., by a mouse-over) but not adding default clutter to the display. For a user an individual filename serves mainly to locate the file within a project (who created that version, where it belongs in the version sequence, etc.), and this purpose is subsumed by the present display. A common naming style is to include the date, as in ‘GladiusDei02March2009.pdf”, but enforcing such a style among disparate collaborators is often impossible. This temporal function is also handled by the spatial arrangement in the window 600, so that the individual file names become dispensable. Our preferred embodiment omits most of them by default, though if there is more than one root to the descent tree the default may include their names. Any names not shown should be available to the user, for instance by a pop-up label responding to a mouse roll-over, or by other means evident to one skilled in the art, but the user should not be overloaded with low priority information. Other information than user identity may be encoded in the column structure 601, such as what department or company is associated with a version (it may be more important to notice input “from Finance’ or ‘from their lawyers’ than to recall personal identities), or ‘in’ which branch of an OS folder system the file is stored. According to the particular embodiment, it may also be used to convey file size, file type, tags or other metadata. Labels attached to individual icons may also indicate information that in a particular embodiment, column placement does not.

The example of Drawing 6 shows icons for only twelve files, belonging to a common project. Applying the method disclosed above for assessment of provenance to a large set of files will often find many separate connected components. If there are too many files to display as a (disconnected) descent tree, it is useful to iconize the current universe into descent groups. Three grouping schemes useful in different situations are to list connected components, to list roots (of which there may be more than of components), and to list similarity clusters of leaf nodes. The first scheme gives a single icon to the descent tree of the ‘plan with pasting from a white paper’, noted as an example above. Clicking on the icon would open the combined tree. By the second, the plan and paper would each have an icon, and clicking on either would reveal the files descended from it. The third scheme clusters the leaf nodes by similarity, to avoid using display space on near-duplicates. In the ‘plan and white paper’ example, the plan and the white paper might each have several leaf nodes if multi-author revision is ongoing, but these fall easily into two distinct similarity clusters by almost any measure of similarity, such as percentage of matched paragraphs, or even vocabulary used. An appropriate click on an icon opens a display of the files from which the corresponding cluster has descent: for the plan this includes drafts of the paper (up to the version from which a piece was drawn for the plan), but clicking on the white paper leaf-set icon does not open files belonging to the plan. The ‘used material from’ relation between the plan and the paper gives an asymmetric link which may be displayed at the overview level by a window which shows files belonging to multiple projects.

In our preferred embodiment the descent tree also supports specific selection processes, so that with a single command (preferably implemented as a mouse click) the user can select the connected component to which the current selection belongs, or the set of files from which it has descent, or the set of those which have descent from it. If several icons are selected, the default behavior is to show the union of their components (the files connected to any of them), but the intersection of their ancestry or posterity (the files with descent to, or descent from, all the selected files). Another single-click selection is the set of leaf nodes of the descent tree, exemplified by the two nodes 630 in Drawing 6, which are typically the most urgent to be considered in creation of a new version, and between them to contain the earlier changes that are worth preserving. The user may add or remove nodes from this set (preferably by the familiar “Control-Click” method). The set is then available for functions such as drag and drop (to a new location, into an application that will open them all, etc.), search within their content, and so forth.

In the above described embodiment, more recent files appear above the earlier ones, but other arrangements will be evident to one skilled in the art, within the spirit of the present invention. In particular, as is common in the graphing of quantities such as temperature or income over time, time may be represented as increasing toward the right. Drawing 6 shows only sequence information, with later icons placed higher, but an explicit time scale may be added by various means evident to one skilled in the art. In particular a uniform time axis may used, so that a long time without new versions is manifest as a spatial gap, or a space-saving scheme that suppresses such gaps may be used. Drawing 7 illustrates this, as well as using a right-to-left direction for time, and showing the use of provenance and flow in managing or participating in a cooperative project. The display 700 may be part of a window called up via its own icon on the desktop or other OS display, or via an application that makes use of a provenance service, or an embodiment of the present invention within an application's own code. The border preferably includes a project name display 701, and a movable time-point 721 on the ‘base line’ bar 720: evidently, these could equally be along the bottom. It also includes identifiers for project participants (like the collaborators 611, 612, 613, 614 and 615 in Drawing 6), here shown as markers 710, 711, 712, 713 and 714, in whatever number is needed. Markers in a given embodiment may be names of individuals or departments or organizations, nicknames, thumbnail photographs, colour codes, etc., as convenient, in ways evident to one skilled in the art. The display is preferably personalized, by placing nearest the base line (in this example, highest) the marker for the user who currently has the display open. Optionally, a user may customize the display, for instance replacing an un-memorable name by ‘Pointy-haired Boss’ or ‘PhB’, without this replacement affecting the display seen by others. The list of collaborators is mutable, with means of addition, deletion, invitation, etc., at any stage. In our preferred embodiment these are handled as in the USPTO application “A Method and System for Invitational Recruitment to a Web Site” by Poston, Shalit and Dixon 70/891534, but other interface mechanisms will be evident to one skilled in the art. By default at least the current user is included, as in the example display 701, without specific action by the user: the change from example display 701 to 702 illustrates the effect of addition of new collaborators. A means may be provided to start a new project with the same collaborator list.

We follow the sequence of displays that appear to the originating collaborator, as versions proliferate. The displays that appear to the other users are similar but not identical, in ways that will be evident to one skilled in the art. The user inserts an initial draft by creating it a word processor linked with the provenance support system, and saving it by a menu choice that automatically includes insertion, or by clicking a ‘create new file’ option similar to that provided by a Windows™ folder, or by dragging the icon for an existing folder into the display region 700, or by such other means as will be evident to one skilled in the art. As in view 702 the display iconize this insertion by a short line 730, moves the time-point 721 to a new position on the base line 720, and optionally adds a curve 731 connecting the insertion marker to the current time point 721, to show it as available and active in the base line 720. The user may then share it with all collaborators (in the example, 710, 711, 712, 713 and 714) or a subset chosen by a standard mechanism such as Control-Clicks on the markers. The display then shows the connecting curve 632 (some embodiments may omit this), and line icons 733, 734 that show the version to be available to the corresponding collaborators: the user's own copy 704 is shown in a different style to indicate that it is not currently awaiting action. The ‘pending’ state for the others is here indicated by dashed lines, but many other indicators such as the use of color will be evident to one skilled in the art, within the spirit of the present invention.

Typically, the user now moves to another activity, returning when the effects of other users' actions appear, as in view 730. In our preferred embodiment, the system notifies the user by additional pathways such as email, or a screen ‘pop-up’ window, when other users have acted.

The view 703 assumes that user 710 has not reacted, so the line icon 733 is still shown in the ‘pending’ style. However, user 711, 712 and 713 have created their own versions 741, 742 and 743, which are thus shown differently: our preferred embodiment color codes them individually according to which user they are from, using matching colors visibly associated with particular user identities and applied also to the markers, but for exposition here we use line styles.

Optionally, the display may be extended to show not only what each collaborator has done, up to current date, but what that person is scheduled to do, either by voluntary commitment (“I will do the section on The Dynamics of an Asteroid before I leave for the Mathematical Congress”) or by assignment from a task organizer, who may be granted sole editing privileges for such scheduling. In either case, a user who completes a scheduled task can indicate the fact, which then becomes a part of the display. The dependencies of tasks on the completion of other tasks, as in a Gantt chart, may be shown by graphical means evident to one skilled in the art.

In a preferred embodiment, while planning a complex schedule the quantitative time display may be turned off, leaving only the sequential dependencies. This is preferred because the initial planning breaks down a project into large chunks, which the planner then subdivides, whereas good time estimates are typically practical (except for an experienced manager planning something without new elements) once the breakdown has reached sub-tasks requiring a few hours or days. At this point the estimates for these tasks can be recursively and optionally probabilistically summed by the software, giving times or probability estimates of times for the higher-level pieces without distraction from premature guesses. In the case of a truly exploratory process, particularly where there is no one person in command (such as a negotiation), or where success in a key experiment may come with the first set of parameters or with the hundredth, it may be best to operate throughout in sequence-time mode rather than in time-coordinate mode. In this case the display functions as a ‘road map’ showing the branched way to the goal, rather than a time-table.

In the transition to view 705 the user has nothing from user 710, and decides to ignore the contribution from 712 (perhaps he mainly offers small revisions of grammar, which would be better absorbed later—if the text they apply to is still there—and not worth making now if it is not). The user's own version 734 and the two selected versions 741 and 743 are taken into the active set, indicated in the baseline 720 by a group 750 of line icons that echo the styles, colors or other identifiers of those in the central display area 700. These are then to be worked on together. This requires a unified display of the current set of versions, rather than a set of windows—overlapping, cascaded or grid—which the user must somehow align. (The grid solution to simultaneous visibility is particularly unfortunate when combined with ‘what you see is what you get’ formatting, with line breaks following final print layout.

With more than one column of WYSIWYG windows, the user must choose between seeing only part of each line or seeing fonts too small for pixel display.) Our preferred means of serving this process is the multi-file editor disclosed in Poston, Shalit and Dixon, “A Method and System for Harmonization of Variants of a Document”, USPTO application number 60939865, 24 May 2007, where any sufficiently large block of material shared between said plurality of files is shown only once, while differing material is shown in parallel columns with information as to source (Drawing 8). Further interaction details relevant to the editing process are disclosed in said application: we describe here the aspects most significant for display.

The display format assumes a current ‘reference’ or ‘baseline’ document F, which may be set either at a group level or individually. An individual user might explicitly click a version's icon to assign it this function, or the most recent version submitted by that user could serve as default reference unless explicit user action overrides it. At the group level it could be specified as the most recent version submitted or approved by a user registered as the group leader, principal author or editor, etc. (In the initial set-up of a project in a mode which admits this rôle, our preferred embodiment assigns it by default to the user doing the setup, but with an option to assign the rôle elsewhere. At any point in the project the leader may pass the role to another user, optionally with provision for revocation of the assignment. Means for implementing these options will be evident to one skilled in the art.) Alternatively, it may be the latest version agreed by all, by whatever consensus method is implemented in an embodiment and chosen by the users, using whatever synchronization protocol. Alternatively, it may be the earliest version, though this is not our preferred embodiment, since accumulating differences make that version becomes less relevant, and require more space and complexity to display. Alternatively, a set S of versions may be selected, in our preferred embodiment as the set of leaf nodes, and the system may assign a common reference version by various means. This reference version may be the earliest member of S, the most recent member of S, or the ‘most central’ member. (For instance, “the quick brown fox” is nearer to both “the slow brown wolf” and “a quick red fox” than these are to each other, giving it a smaller differences total.) To define explicitly this we construct for the set S a dissimilarity matrix P as done for the set U in the descent tree construction described above, and set Δᵢ as the sum or sum of squares of the entries ψᵢⱼ for all j in S, or combine them to a single number by any other means that increases with each ψᵢⱼ. The most central i is then that version for which Δᵢ is least. Many alternative measures of difference, and means of combining them, will be evident to those skilled in the art within the spirit of the present invention.

We create a single data structure describing the baseline file F, and the differences between F and each other file f in the set S. (We do not, in our preferred embodiment, create an explicit representation of the differences between any two non-baseline files in the set S.) Our preferred embodiment uses a tree representation of F, where the ‘root’ of the tree (referring to the whole file) has nodes logically attached to it which represent parts at the next level of subdivision (chapters or sections in a book, movements in a symphony, class definitions in some kinds of code, etc.), these have nodes representing subsections, passages, code blocks, etc., down to the level of the individual word, bar or other chosen basic unit. (We prefer not to extend this representation down to individual letters or notes.) These ‘leaves’ have integer identifiers which recur in separate occurrences of the same word: higher nodes have unique identifiers. We observe that within the spirit of the present invention an embodiment could use other data structures, such as a sequence of words with included markers like the HTML <p> and </p> for the start and end of a paragraph, and a markup of changes like the ‘bracket notation’ widely used in the United Nations. By analogy with the HTML method one can mark the beginning and ending of an insertion by user Sheila as <inserted author=“sheila”> and </inserted>, and similarly for other changes. This ‘flat file’ approach is not our preferred embodiment of the present invention, as code for editing would run more slowly with it than code exploiting a pre-processing step that builds a tree structure, but it is a possible embodiment.

Having constructed a unified representation of the baseline and other files, we display it to the user as shown in Drawing 8. This is somewhat stylized for clear reproduction within the present document, showing a smaller set of words in larger letters, and without colour coding, but illustrates the spatial layout and interaction central to the present invention.

Where material is identical between the various versions, the viewing window 800 shows text in blocks such as 801, 802 and 803 that use the full width available. (This width may vary, with resizing of the window by the user or other factors.) A segment like 811, for which alternatives have been proposed in other versions, appears in a column (shown as leftmost) with one or more of those versions parallel to it. In the case shown, one version proposes a deletion 813, move 814 and re-insertion 815 of the material 811. The same version proposes within the material 811 the deletion 820 of a redundant-word, which proposal is reproduced 821 in the re-inserted view 815. Parallel to the insertion 815 is the blank column 810, showing that the baseline document had no material between the segments 801 and 802. A shared color for the deletion markers 813, 820 and 821, or their backgrounds, associates them with the particular version in question, or with its author. (A color key is preferred to be included in the frame of the view, or easily summoned by a suitable click or clicks: many designs for this cue will be evident to one skilled in the art.) Where a change such as the deletion 830 (or a like small substitution or transposition of words, not shown) is small enough to show in a readable manner within a single line, our preferred embodiment does so rather than creating parallel columns. Above a threshold density of such small changes, however, the display changes to multi-column.

An embodiment may enable a user to ‘second’ a change proposed by another, adding an identifier for the seconder to the name, color or other marker by which the creator of the proposal is identified. This may encourage other authors, or the author (if any) with final decision power, to adopt that change.

If a user edits that user's own contribution, this automatically creates a leaf node version originating with that user, overriding display of that user's earlier versions unless an Undo or time travel facility (as disclosed below) is used. A user may also withdraw a proposed change, for instance if another user has proposed something the first user likes better. (Optionally this may become part of the display for these and other users, for instance by marking the first user as a seconder of the second user's proposal.) Note that such withdrawal is distinct from deletion, which creates a suggested replacement of the corresponding baseline text by an empty string.

An editor may use other formats to lay out such an integrated display: the use of any such will be recognized by one skilled in the art to be within the spirit of the present invention, which addresses the aspect of selection and comparison across files, rather than the merging task. As in Poston, Shalit and Dixon, “A Method and System for Facilitating the Production of Documents”, USPTO application number 60884230, 10 Jsn. 2007, the differing material may be shown interleaved with the common material, across the full width of a text window, but this is not our current preferred embodiment. Various word processing products offer automated document merging, usually of only two documents at a time, and never approaching human quality in the blend, but submitting the chosen group 750 to such an automated merging process is also within the spirit of the present invention. Absent a multi-file editor or automatic merge process, the selected set may be dragged to the icon of a standard single-file editor, which following normal protocols will open a separate window for each file, usually overlaying each other on the desktop. The user must then slide each window and its contents around to make the necessary internal comparisons, but the descent tree does at least make it easier to be sure that all relevant versions are being compared. In our preferred embodiment, the software providing the service ensures that saving from any editor opened through it creates a new file (rather than overwrite an old one) with descent from said file and preferably from any others from which material is cut and pasted into the modified file, if sufficient integration with the paste system of the user's environment is available.

Authors in differently equipped offices may between them produce .doc files, .docx files, .pdf file, .tex files, and so on, unlike in-house production of documents by an organization that polices its members to stick to one recension of one standard. To be most useful in collaboration between such authors, a multi-file editor for merging and comparison should be equipped to read files in all widely used document formats, and export edited files in any of them. Our preferred embodiment of the present invention would pass a selected set of files to such an editor, but the present invention itself addresses relations between files rather than the construction of a multi-format multi-file editor.

As a particular displayed-flow application we include the case of a ‘wiki’: a document created on line by multiple author/editors. The current art is to display only the most recent version, without distinguishing changed text. This is satisfactory for some purposes, with occasional synchronization problems where two authors modify the same segment in overlapping time, but in others it raises problems of authenticity and approval. In some wiki software a change by a low-ranked or anonymous editor is adopted and displayed only when approved by an editor with a higher level of authority: an intermediate level allows an author to have changes accepted without waiting for approval, but does not include that author in the approval process for others. (Various methods and systems exist for automated or human assignment of approval authority: we disclose below provenance-oriented extensions of such.) This reduces for new authors the immediate gratification of seeing their change become visible to all, and thereby risks losing their contribution.

Our preferred embodiment of the present invention applies a display similar to Drawing 8. If only a small set of authors is involved in the wiki, each may have a default column in which that author's more substantial changes are displayed, though this is not essential, and cannot be sustained with a larger group. Unless the set of active authors is very large, color coding by author is a part of our preferred embodiment.

A particular wiki user always sees every user's most recent active version of any particular sentence, paragraph, or larger unit, whether or not that version has been accepted by one or another means (see below) as currently canonical. If there is no disagreement on that unit, it appears like 802 and 803 as full-width text, but may be colour-coded as ‘my input’. (Where an extreme form of column-per-author for a small group is in use, we prefer that the inevitable white space in a typical column, representing sections of the text for which the corresponding author has not created a variant, should be reduced by allowing some vertical overlap in their display text regions.) If there are competing versions of that unit—including the ‘empty version’ from deletion, like 810 or 813—they appear in parallel columns like 810, 812, 813, 815 and 816, with the most recently unique or canonical version in a distinguishing position (by our preference, left) like 810 or 811. As in other uses of this format, lines like 840 across the non-canonical columns or other such graphical devices as will be evident to one skilled in the art, may be used to sharpen the visual distinction between such columns and the current reference one.

Whether in a wiki embodiment or in the model of circulated drafts, any author may modify a unit of that author's own text, or may recall or revert to an earlier version of that text by the ‘local Undo’ described below: sliding the time control back or forward may act, according to the currently selected text, on the user's own column or on all columns together. An author cannot modify, but may be enabled to second (as above), material displayed as from another author. (Optionally the user may clone a duplicate of the user's own current version, for simultaneous comparison display of the duplicate regressed in time with the current version.) In particular the user may accept the currently canonical version; or accept and optionally second another competing version, upon which that user's version of the unit disappears as an active version, and is no longer displayed except where the time is regressed. In pure co-operative mode result of different users' accepting in this way creates a unique and hence canonical version of the unit. In the not-uncommon situation of two competing views of a topic, such as a historical or economic article, the unreconciled differences remain visible to all users. This has the treble advantage of avoiding the current-art flip-flop as each opponent keeps switching the wiki back to a preferred view, displaying the fact of dispute in a clear manner, and allowing the reader to compare the opponents' claims and reasoning in a closely aligned simultaneous display. This acceptance process in pure co-operative mode may be supplemented by such tests as ‘reject for general display if an uninterrupted sequence of N other users working on this unit have failed to accept it’, for some number N set by community rules, or by a voting scheme, or by many other means that will be evident to one skilled in the art. However, our preferred embodiment uses the above consensus approach, by which a unit version becomes canonical through acceptance by all those who have expressed a view.

Where the system includes human editors with authority, such an editor may accept a competing version as the new currently canonical one, or reject it, optionally attaching a comment to explain why. In our preferred embodiment the author will continue to see the rejected version, marked as rejected and with any attached comment, but it becomes invisible to third parties such as other authors or readers of the document. Where the system maintains a distinction between authors and readers (for example, an on-line product documentation wiki may permit every company member but no outside person to make changes), invisibility may be applied to the users with read-only access. Optionally, a non-default ‘rejections included’ view may be made available, for such purposes as examining the behavior of those in authority.

In either the consensus mode (pure or with voting) or the mode where one or more users have authority to accept or reject the versions of others, the count of a user's changes that are accepted or rejected may be accumulated and stored, as may the times that a user accepts alternate versions (a measure of cooperativeness). These counts or their ratio may be displayed to the individual user as feedback, on a collective or individual page visible to all or limited to persons with higher editing authority or to persons in organizational authority over that user. They may also be used for automated recognition of a harmonious contributor whose contributions are welcomed and who seeks resolution over conflict, reaching the status of automatic acceptance (which in the present context means that a change becomes canonical without delay) or the higher status of gatekeeper to others. Since an author may accept small or partial changes like 820 or 821, as well as replacement of whole units, it is a highly preferred part of an embodiment of the present invention to track not only immediate acceptances by another user, but the survival of a user's changes through the continuing editing process. Identifying such mixed provenance graphically in the standard display is unduly complex, but if the version descent graph is constructed and maintained as above it adds a powerful test for the durability of a user's contributions, by the size of the sub-trees through which their changes persist, and all the power of directed search and time-line manipulation described below. We strongly prefer that this provenance-oriented wiki be implemented as part of a general provenance management system, in which the users' contribution record is maintained if (for example) a wiki is converted to a non-dynamic document, or all or part of such a document is imported as the initial full version or as an insertion or partial replacement in a wiki. All the tools disclosed in the present application are then applicable to the wiki as well as to circulated-version documents, and to the wiki as a sub-process of the larger development work. This permits not only the integrative effect of the wiki method as a self-contained co-authoring scheme, which has been widely discussed, but integration of the wiki method itself within the larger document development of an organization or group which may not prefer to be wholly wikid.

As another displayed-flow application we include the case of multi-person ‘chat’ over an intranet, internet or other network. Like a wiki this shows a window into which a plurality of users can enter material. In this case it is typical for each user to have a separate window in which to prepare a unit of text, from which it is submitted as a unit, rather than display one's on-going hesitations, deletions and corrections to the view of others, but versions without this separate submission step are also available.

Unlike a wiki, a chat identifies the source of every submission in its display, usually by including a user name or pseudonym, and does not permit changes (even by the original submitter) in content once submitted. The provenance information lacking in this case is again a synchronization problem, since users prepare their submissions in overlapping time intervals. This is not a critical problem in the widest current uses of chat (‘hanging out’ with virtual companions, venting feelings, and exchanging sexually focused sentence fragments with strangers): with none of “How ya doin” “I hate my history teacher” or “That feel sooooooo nice” does the previous submission matter much. But in an exchange containing reasoning or facts, such as

| | |
|---|---|
| Marco: Welcome back! | (A) |
| Sindhu: Hey, you're on line! | (B) |
| Marco: Where were you last week? | (C) |
| Sindhu: Good to touch web again! | (D) |
| Marco: and where you now? | (E) |
| Sindhu: Rio de Janeiro! In Brazil! | (F) |

it is quite unclear whether Sindhu started typing (F) while (C) was the latest visible message from Marco, or responded (faster) to (E). (In (D) she replied to the welcome (A), not to the most recent submission (C) from Marco.) If she next sends “Back in Delhi” this is clarified, but she is just as likely to move on with—for example—“You in Paris now?”. With more complex discussions the difficulties multiply. With more than two participants there may be several entries between any two of hers, and it is harder still to guess what she is answering.

The embodiment of the present invention appropriate to this problem is to record and display the provenance of each submission, as estimated by the system and optionally modified by the User. Each submission S other than the first normally has a ‘referent’ submission among those previously posted. By default it is the submission by another user that is most recent when S begins to be typed. The user may modify this, by clicking on another submissions or on several others (preferably with the familiar Control-click mechanism for multiple selection), by moving a current-selection indicator up or down with a keyboard arrow key, or by other means that will be evident to one skilled in the art, within the spirit of the present invention. The user may also remove the referent choice to indicate a remark not prompted by a previous submission, by (for example) an Alt-click, or by such other means as will be evident to one skilled in the art as appropriate for an embodiment of the present invention. The display as in the frames 900 or 910 of Drawing 9 is analogous to Drawings 1 and 6, save that the items related have small enough content for the content to be displayed directly, rather than the items be iconized. Drawing 9 shows response provenance by lines 901, 903, 905 and 907: the difference between line 903 in view 900 and line 907 in view 910 suffices to make clear that reply 909 means “I am in Rio”, whereas the reply 911 means “I was in Rio last week”. Many other means of display will be evident to one skilled in the art, within the spirit of the present invention. In particular, lines may be color-coded according to the identity of the responder, of the reply responded to, or (shading from end to the other) of both. A line may pass under or translucent over a segment of displayed text, or go around it to left or right, as judged effective by one skilled in the art, within the spirit of the present invention. A particular item may be connected to zero, one or a plurality of referents, or of submissions referring to it. In our preferred embodiment submissions are typed in a separate window, but alternatively they may be entered in place within the display. Successive keystrokes and corrections may be displayed to other users, or submissions made as a unit, when the user so signals by pressing the Return key, clicking a particular button, or such other signal as the particular embodiment and the user's set preferences may specify. By scrolling up, the user may select an earlier submission (by another user, or the user's own), optionally in a previous session, and resume a discussion from that point by using the same mechanism: means such as separate windows or variable compression (as in Drawing 11) may be used to make both ends of the response link visible. Our preferred embodiment makes available the full set of provenance-enhanced services as disclosed in this application, so that the user can find submissions within the chat that have not been answered (leaf nodes of the descent graph), search the ancestry or posterity of a submission for a particular search string, and so forth. This within chat provenance flow may form, in a manner evident to one skilled in the art, a subgraph of a larger descent tree in which a single wiki is embedded, where other documents may have descent from it by quotation or reference, and it may have descent from other documents quoted, cited, excerpted or referred to in it. Where a plurality of chat sessions involve substantially the same set of users, even if initiated as new sessions, string matching between sessions may be used to detect automatically that one session is a probable continuation of the discussion in another, making descent visible and usable to the system user by any of the features of display and contextual provenance-enhanced search disclosed in the present application.

Returning to Drawing 7, in view 706 the new version drawing on 741, 742 and 743 has been created, and the time-point 721 moves to reflect it as current. The versions drawn on are now iconized as a curve 751 leading to the active merged point 752. The inactive stub 733 (where user 710 has not yet acted) remains visible, and the unused revision 742 is redrawn as a longer element 755, still available for use and visibly not yet dealt with, reaching forward into time to match (view 707) the new stubs 763 and 764 resulting from distributing the merge 762 to all users in the group. When 708 the users 711 and 713 have responded with further revisions 771 and 773, these with the current user's latest versions become the element shown in ‘to be worked with’ color or line style or otherwise distinguished, and so the process continues. Note that the merge 752 would appear to a second user not in the personal baseline 720 of the first user, but as a ‘to be worked with’ element on the line corresponding (in the second user's view) to the first user.

In our preferred embodiments the above descent display (with versions or with clusters of similar objects as nodes as nodes, and in the style of Drawing 6, of Drawing 7, of Drawing 10 or of another such descent tree display as will be evident to one skilled in the art) is not merely an inert view, but a means of interaction. First, there is a selection mechanism. Analogously to current folder displays, the user can by mouse clicks or analogous interaction gestures select a node, or those nodes within a selection box, but the descent tree allows us to go beyond these methods. Navigation gestures include not only clicking on a node where the cursor is presently displayed, as in current folder windows, but clicks or key presses that move the selection point (visualized by a highlight, or other such means) along displayed descent links. For example, a press on the up-arrow may move the highlight from an icon A to an icon from which it has direct descent; if there are more than one such, the selector may move by default to the parent displayed at left-most, the parent at right-most, or the parent closest by the similarity matrix ψ or another similarity measure.

If the next command is a left-arrow press, the highlight moves to the next leftward of the coparents of A; a right-arrow press moves it to the next rightward coparent. A press on the down arrow moves the highlight to a direct descendant of the current choice (left-most, right-most or most similar), and an immediately subsequent left or right arrow press moves the choice of child to left or right. These motions extend the current behavior of moving up and down a folder contents list, in a way that is only possible and useful if the icons are arranged in a graph whose structure is informative. They also integrate with structured search (see below).

The user may also modify the current view of the region of the descent tree that is currently visible, and affected by further actions. An enlarged view may show only part of the currently displayed subtree (figuratively treating the rest as ‘displayed but beyond the window’), which may automatically give prominence to the currently highlighted icon, recentering when the highlight moves. This may be implemented in a 2D display as in Drawings 6 or 7, or in a display that shows on a larger scale the parts of the descent tree around the highlighted point. Many ways to do this are possible, analogous to a mobile virtual lens, or the hyperbolic trees discussed in the Background to the Invention, etc., but our current preferred embodiment is the view shown in Drawing 10. The descent tree 1000 (matching part of that in Drawing 5) and the user icons 1011, 1012, 1013, 1014, 1015 appear in perspective, and the currently highlighted icon 1050 appears in the foreground of the view. The navigation and selection tools described above function also in this version of the display, and 3D navigation tools such as those familiar from video games can modify the user's point of view and orientation. It is also possible within the spirit of the present invention to show the descent tree in a non-planar 3D configuration, subject to the availability of convenient means for the user to interact with 3D objects.

Each node of the descent tree has a ‘node menu’ which when evoked may appear as far from the application as the desktop allows (frequent in OSX software), or as a ‘tooltip’ near the node's screen icon, or in such other places as suit the interface style expected by the user, as judged by one skilled in the art. To evoke it the user right-clicks the node's icon, rolls the cursor over it, or selects it and clicks a button in the frame of the display, etc., as suggested by the interface context. When opened it offers buttons for (as an exemplary sample of possible functions, neither exhaustive nor compulsory) opening the version indicated by the node, sending it to a printer, searching forward or back from it (as described below), highlighting its ancestors or its descendants, etc., as needed.

An important feature of the descent tree presentation of the flow of a project, whether in the style of Drawing 6, Drawing 7, Drawing 10 or another style within the spirit of the present invention, is the fluidity with which it can handle the processes of comment and critique. Many word processors have a mechanism for adding a comment (with its presence marked by a highlight, a marginal note, etc.) that is in the text but not meant to become part of it, for removal later. Merging with a multi-format multi-file editor, as discussed above, is clearly more efficient if the editor recognizes such highlighting in all the formats it reads, recognizes it as creating differences, presents it in the integrated display, allows removal and addition of comments and exports them in the various formats it supports. However, this is far from exhausting the ways in which a project's flow may involve comment. One user may respond to a version from another by editing comments into it, creating what we would handle as a new, commented version: but equally may respond by writing an e-mail, a critique in a different document format, by sending a document by someone else with a remark such as “This experiment appears to contradict our assumption that sound travels faster than light: we should discuss it in the Previous Work section”, or “Might the examiners consider the exposition in the attached science fiction story to be prior art? We should discuss the differences”, or “In light of http://ohhhno/oops.htm, should we revise Section 4?” A thesis adviser, for example, might feel it improper to edit a student's actual sentences, but be very ready to describe problems and possible remedies. A group of scientists collaborating on a paper may typically interact by sending around revisions, but when the scientists have converged on a submission version it will come back from the journal with a set of referees' reports. The authors must then re-enter the process of exchanging versions, this time addressing the question of whether they resolve the questions raised by the reports. A ‘Track Changes’ mechanism, already unwieldy when there are more than two authors, contributes nothing to this, even if the referees could be persuaded to turn such a mechanism on. The reports are not themselves versions, and are in whatever formats the referees prefer. The present invention provides a flexible solution to this class of problem.

At any point, a user may add an item to the descent tree or project flow display. For project control its effective date is its date of addition, though its creation date (as recorded by various means) may be earlier. The addition may be, as above discussed, a revision (created with any editor) of an earlier version. It may be a critique of a version. It may be an independent document, considered relevant by the user. It may be a URL or URN, in which case an embodiment of the present invention may either download the document it refers to, or store only the URL as a pointer, accessing the object it points to only as needed. It may be a selected section of an e-mail existing as a discrete file only after it has been added. It may be an image, a recorded symphony or a simulation specification that requires comment. It may be a set of test data on which the algorithm code version at a particular node, or at all nodes from now on, should be tested. If the project is a visual or multi-media one, it may be an image to be included, or from which material may be obtained for inclusion. Many other examples of an addable item will be evident to one skilled in the art, within the spirit of the present invention.

Adding an item may be performed in various ways, not every one of which must necessarily be instantiated in every embodiment of the present invention. The user may drag the icon for a file into the project flow display: if the descent tree system is running on a single local computer it may store only the address of the file (particularly if the OS incorporates the present invention sufficiently to store provenance data and to arrange that each ancestor can be located as a file or can be reconstructed), or it may make a copy of the file in a new disk location. If the system is running on a central server, a typical embodiment will upload the file. The user may save a file into the descent tree system, from an application. The user may drag a URL, URN or link into the descent tree display. The user may open a menu attached to the descent tree display and browse for a file to be included. Many other means of adding an item will be evident to one skilled in the art, within the spirit of the present invention. In a display organized according to originator, like Drawings 6, 7 or 10 but unlike Drawings 1 and 4, the new item becomes associated with the user who adds it.

When an item is added, it must not only join the set of nodes, but acquire appropriate provenance links to nodes already present. If the item is a new version of a text under development, the comparison methods described above suffice to assign these links automatically. If it is a critique or new background material, the user must provide the links. In one method the user may drag and drop an icon specifically onto the icon for a particular node, upon which the system assigns a direct descent link from that node to the new one. In another class of methods, which may be used with the first method if the user requires more than one link to the new node, the user may ‘rubber-band’ a graphical link, or left-click the new node then right-click the nodes it is to have descent from (or the embodiment may dedicate Control- or Alt- or similarly modified clicks to similar purposes), the user may select parents for the new node from browsing menu, and so on in many alternative ways that will be evident to one skilled in the art, within the spirit of the present invention. A user may open a node menu, click on a ‘Comment’ button therein, and type into a text window that appears. Upon exit, this material is stored as a text file with descent from the node whose menu was used to begin it, thus combining insertion, creation and linkage. A user may copy material from another document or email to the OS scratchpad and paste it into such a window, or click a ‘paste’ button in a node menu which has the effect of creating a text file, inserting the scratchpad material, closing the file and creating a provenance link from the node to it, with a single click. Many other means to add a descent link to an item will be evident to one skilled in the art, within the spirit of the present invention. A means to add a provenance link that does not include creation of the linked to node may also be used anywhere else in the descent tree, for instance if the user observes that an automatically created descent tree has missed a link that should be included. Conversely, selecting a link and pressing the Delete key, or similar means evident to one skilled in the art, may be used to remove an undesired link.

When a node A is added and linked to an existing node E, the system attempts to recognize it as a revision of E, by its possession of material matched to E. sometimes this fails: perhaps A is of a different type, like a text file reacting to a PhotoShop™ project, or both contain text or both contain images but with only trivial matches. In this case, our preferred embodiment does not modify the ‘leaf node’ status of E though it has A as a ‘descendant’, since the existence of A does not mean that changes originating with E have been taken into account by a later revision.

Where possible, a multi-format multi-file text editor opened with both revision material and comments (recognized by the matching criterion just described) it should where possible connect the comment material to text referred to, including it in the parallel columns or other method used to show local connection between files: this possibility exists without semantic analysis where the comment quotes the revision material, or both quote the same material from elsewhere. Where it is not (in particular, where the non-revision material is suggested background, rather than critique), we prefer that the editor should open with the non-revision material at the head of the unified display.

As further displayed-flow application we include the case of tracking bugs in computer code, where ‘bug’ is broadly interpreted to refer to any undesirable behavior, including but not limited to causing the program or the computer to halt unexpectedly, returning a mathematically or logically false result from a computation, responding to user input with an action that is not according to the specification of the program's behavior, or conforming to specification in a way that is discovered to confuse or impede the user, so that both specification and code require change. The filing of a ‘bug report’ drawing attention to the problem may be handled by the ‘comment and critique’ mechanism discussed above, which also permits (as many bug report mechanisms do not) the addition of background material such as a discussion of the errors typical with a particular mathematical function, such as that the usual single-argument arctangent function cannot report a right angle correctly, or more sophisticated logical problems, or a web page discussing ways that a user may be misled or taken through many selections, or a guide to color contrasts that work well with users with Daltonism or other non-standard visual perception. Items descended from such a report and/or link may include discussions about what changes (if any) are required and their priority level, methods to be used, revisions of the specification, and revisions of the actual code (which may also be embedded in a classical ‘check in and out’ version control system). This flow mapping may seamless embed in a overall project flow display, beginning with initial discussions of the desirability of a particular piece of software, through the discussion of goals and specification, to the revision management just discussed, and onward to documents recording marketing, sales and user feedback, with use of all the features of display and contextual provenance-enhanced search disclosed in the present application.

A feature that may optionally be included in an embodiment of the present invention for group use, where files organized by the descent tree are accessible through a shared server, is the inclusion of material with restricted visibility. For example, a non-native speaker of French, collaborating on a scientific document in that language, may wish to have private input from a language specialist, not to critique the science but to correct a version's use of irregular verbs before exposing it to a Parisian colleague. Similarly, a user in one company working jointly with members of another company on a document describing a proposed joint project or contract may wish to keep private from the other company certain assessments of legal or financial implications. However, such a user need not forgo inclusion of the specialist's input to the integrated editor, if this material is marked as for view only by the user personally, or by a designated subset of the group. This facility has evident possibilities for ethical abuse (for instance if a student writing an essay under the supervision of an adviser seeks assistance that the student's adviser should know of, for accurate grading), but it has legitimate uses, and it is no more the function of multi-author software to block cheating than it is the function of a single-author word processor to prevent libel.

### Directed Search

The display and selection tools discussed above, whether using similarity or descent, are in our preferred embodiment integrated with search. Selection of a connected component of the descent tree, or of the ancestry or posterity of a file, or any set within the current universe, enables search restricted to that set. An entity to be searched for may be a text string (as is common in search engines) entered in a query box, or it may be an element in an open file; selected text, a selected image or part of one, a structure in a scene, etc., according to what elements the embodiment is able to match. In the case of text our preferred embodiment allows related terms such as plurals, and in no case need the match be perfect, unless the user so specifies: the user fixes (for instance, with a slider, or by typing or selecting a number, or by other means evident to one skilled in the art) the degree of matching required. In any display where the window shows icons for files or for clusters or trees of files, a search managed via the window indicates which icons correspond to locations of matches; multiple matches may be indicated by brighter highlighting, faster pulsing, more points of light, or such other means of indication as will be evident to one skilled in the art.

Where the current display is a descent tree, our preferred display of the result of a search shows the sub-tree in which matches (to the chosen degree) are found. The display highlights the root node or nodes of this sub-tree, so that the user doing a backward search may easily see where in the version history the element entered the project. Similarly, in a forward search the survival of a search item, and the contexts in which it later appears, can be very revealing in the study of a document's history. It is also useful (particularly if the number of files in the display is large) to enable a direct search for the first occurrence of a search item, for all the ‘root’ occurrences of the item (there may be more than one, if two versions both drew on a source which is lost or not in the range of the descent analysis system), or for the last or leaf occurrences of the search item.

We prefer to show the matches in context, though without requiring full opening of the files in which the matched elements appear. A display such as Drawing 6, 7 or 9 cannot easily accommodate a context display next to each icon, so we prefer to display context in a nearby sub-window. As the user moves the mouse over a particular icon highlighted as containing a match, the best match in the corresponding file is displayed in this auxiliary sub-window. The sub-window may contain a list of fragments with the matches indicated (for example, by a bold font), as is commonly done with search engine results: in this case, a highlight moves in the list to indicate the best match in the file whose icon is currently under the cursor. Alternatively, a smaller sub-window may show only the contextual fragment including the best match or matches in the file whose icon is currently under the cursor. Alternatively, and in our preferred embodiment, a larger sub-window may show a compressed view of the entire file whose icon is currently under the cursor, making the larger context apparent. One means for generating such a compressed view is disclosed in Poston, Shalit and Dixon, “A Method and System for Facilitating the Examination of Documents”, USPTO application number 60869733, 13 Dec. 2006, hereby incorporated by reference, whereby words, sentences, paragraphs, etc., are each given a given landmark value, and only those with a value above a certain threshold are displayed. This threshold may be a single number, resulting in a uniform level of compression, or it may be varied through the file by user interactions (expanding certain parts of the file, showing little of others), or the threshold may be set low near the search match element occurrences, so that these and the nearby words at the same level in the document hierarchy are shown, and set higher away from them, for a more compressed view. Drawing 11 illustrates the results, where the sub-window 1100 shows a non-uniform compression of a document in which exact hits for the word “patented” have been sought. There are two such hits 1110, shown among surrounding words, so that we see inside the sections where they occur. Outside these sections the threshold is generally higher, so that words and sentences do not have high enough landmark value to be visible: section titles and introductory text 1120, nearer the root of the document hierarchy, have higher values and do appear. The user may easily explore further the context of hits, by interactions that locally or globally modify the threshold.

In our preferred embodiment, the same non-uniform compression scheme, under user control, may be used in all the display interactions described above.

### Time-Line Manipulation

The time-point marker 721 in the base-line 720 is placed by default at the most recent event, but in our preferred embodiment it is an active graphic element, usable as a slider. If the user drags it back in time, the corresponding view ‘inside’ the versions changes: we refer to it as the ‘time traveler view’. For example, if the user has opened a document version Xᵢ with the cursor shown at a particular point P in the text, a text display coupled to the descent support system responds to the movement of the time-point marker 721 by showing the text most closely matching text T around the point P, in the version or versions active at the time. For a simple chain flow
X₁→X₂→ . . . →X_{N-1}→X_{N}
   there is one such version Xⱼ, and a display can simply center on the matching text what a standard word processor would show. Even for this simple case, however, our preferred embodiment uses the compressed display discussed above, except that the thresholds are chosen not to be high near search hits (as in Drawing 11) but to be high around the match to T. Alternatively, if the user has acted to adjust the threshold values to emphasize some parts of Xᵢ over others, we prefer to transfer this display structure to Xⱼ. Any text segment in Xⱼ with a strong match to a segment in Xᵢ receives a corresponding threshold value. A segment with a merely moderate match (suggesting that one is a version of the other, but substantially edited) receives a high value, on the assumption that the navigating user finds such differences significant. This makes it conspicuous in the time traveler view. For a segment A in Xⱼ with no plausible match in Xᵢ, we find the largest contiguous such segment Â and give it a low value, tagging it as inserted/deleted text that the user may decompress. For a segment B in Xᵢ with no plausible match in Xᵢ, the largest contiguous such section is necessarily flanked by matchable segments or landmarks such as the start or end of the file, a section, etc. Where these are next to each other in Xᵢ, defining a gap, the time traveler view includes a marker for that gap. Where they are separated in Xᵢ (with the same one first), with unmatched material between them, that material is given a low threshold value, hence shown as a small compressed (expandable) unit, labeled as replacement material by color coding or such other convention as will be evident to one skilled in the art. Where they are in a different sequence in Xᵢ versus in Xᵢⱼ, or where there is matchable material between them in Xᵢ, we do not use B directly to influence the time traveler view. If at some point in sliding the time point 721 the user adjusts the threshold structure manually, this resets the reference Xᵢ to be the file displayed when the adjustments were made.

Where as in Drawings 1, 6, 7 and 10 the flow is more complex than a simple chain, a view similar to Drawing 8 shows the relevant set of files at each time point to which the user moves the slider. The default set taken to be relevant for each such time is, in our preferred embodiment, chosen in the same alternative ways as described above for the current view, as if the files more recent than the chosen time did not exist. Thus, our preferred default set consists of those which are the leaf nodes for the descent tree up to that time, optionally including the user's most recent submission up to that time. It is more practical to display differences from one reference member file than to show all differences between members: this requires choosing such a reference file, which may be done by one of the various methods discussed above (earliest file, earliest leaf node, latest leaf node, most recent leader-approved version, most recent consensus version, the current user's most recent version, etc., all relative to the selected time). Our preferred display format for the set of files remains the partially multi-column format shown in Drawing 8, though alternatives such as inserted slips are also usable within the spirit of the present invention: either a column view or a slips view benefits from the choice of a reference version.

The variable compression illustrated in Drawing 11 is important in the changing view produced as the slider moves, as it allows an overview of the evolving file (or file set) equally with evolution at a particular location. As the chosen time changes, the user's latest view choices (both the focus point centered in the view, and the pattern of compression nearby or across the whole file) are preserved as far as possible. The current focus point is tracked by matching, and compression values in a new view are copied from the best match in the previous one. Where a new view includes an unmatched section of material, if is given a compression value interpolated between those of its matched or partially matched neighbors.

Alternative views of the flow include the ‘user-neutral view’ like Drawings 1, 6 and 10 (including any direction for showing time, such as to the right as in Drawing 1 or downward in Drawings 6 and 10), or views like Drawing 7 (again using any time display direction), where there is a reference version whose development is tracked in the bar 720 or a similar construct evident to one skilled in the art. As already discussed, this reference version may be a globally preferred sequence of files, such as those authorized by a leading user or by consensus, or—for a particular user—that user's own sequence of versions. The displays in Drawings 6, 7 and 10 emphasize distinct ‘versions’ of a file, with discrete moments at which they are received and disseminated. However, if the system retains detailed records of the editing process (either by very frequent saving of complete intermediate versions, or by storing of incremental change information from which intermediate versions may be reconstructed), the same time-point slider can move the displayed text or other material such as an image through such versions, step by step. Visually, moving backward in time by this means is an incremental Undo: if at a particular point the user clicks a ‘regress’ button (in one embodiment) or in another embodiment simply starts to use editing tools, the resulting view is saved as a new version originating at the real time of the user's action. This motion in time is particularly useful when localized: If the user selects a particular subset of the file, such as a section or paragraph in a document, or a layer or an area or both in a PhotoShop™ file, the ‘time travel’ is restricted to that subset, so that the user does not have to undo recent changes in other areas (or merge versions from different times) simply to reverse now-regretted changes in one part of the work.

This time-navigation facility presents to the user as a ‘zooming in’ on the temporal dimension, seeing more detail and smaller changes, with an integrated overall control interface for motion in time, whether between landmarked versions iconized in the descent tree, or through thebediting process. The flow manager in Drawing 7 thus becomes a manager for flow and change at multiple timescales, as well as a localized Undo.

In drawing 12, a schematic overview of a method in a computer system, such as a network server, local computer and/or the like, is shown.

The method enables enabling flow management of digital objects to a user.

In step A1, the computer system determines a set of digital objects comprising at least two digital objects. A digital object may be a document file and/or the like. In some embodiments, the digital objects are documents of different digital document formats and the computer system comprises a multi file editor.

In step A2, the computer system determines provenance data of the digital objects by comparing data of the digital objects within the set of digital objects. Said provenance data may in some embodiments be determined in whole or in part at the time of creation, saving, copying, renaming of said digital objects, by analysing content of said digital objects, and/or supplemented by use of metadata associated with said digital object.

In step A3, the computer system constructs a logical map of provenance among the set of digital objects.

In step A4, the computer system displays at least part of said provenance data to at least one user, such as displaying a descent tree of the digital objects and/or the like.

In step A5, the computer system uses the provenance data to modulate the effect of an action of the user. The action may be a display-modifying or information-seeking action upon the computer system and examples of the effect may be that the displayed logical map is changed upon selection/search from a user. In some embodiments, the user action comprises alteration in a digital object and the map is updated with a new digital object comprising the alteration. In some embodiments, the user action comprises adding a digital object to the set, accepting a change within a digital object, undo a change, selection, a search, moving a time line indicator and/or the like.

In some embodiments, adding a digital object provenance data of the digital objects is determined by comparing data of the newly added digital object with data of the set of digital objects.

In optional step A6, the computer system updating said logical map in conformity with additions, deletions and modifications in said set of digital objects. These may be made by the user, another user adding a version, a search tool running in background discovering a version and adding it, and/or the like.

In some embodiments, additional steps are added. The steps comprises creating similarity and dissimilarity matrices and differentiator sets of the set of digital objects, sorting the digital objects into a list, and/or connecting elements of each digital object.

In some embodiments, the digital objects are constructed into groups in drawing 13, embodiments disclose a computer system for flow management of digital objects is illustrated. The computer system comprises a control unit 1001 arranged to determine a set of digital objects comprising at least two digital objects and provenance data of the digital objects, and to construct a logical map of provenance among the set of digital objects.

The control unit 1001 is further arranged to display at least part of said provenance data to a user and to use the provenance data to modulate the effect of an action of the user.

In addition may the control unit 1001 be arranged to update said logical map in conformity with changes in said set of digital objects resulting from the action. The computer system may comprise an Internet server but may also be local computer of a user.

The control unit 1001 may comprise a CPU, a single processing unit, a plurality of processing units, and or the like.”

The computer system may comprise a memory unit 1007 arranged to have stored data thereon, such as digital objects, sets of digital objects, applications that when run on the control unit executed the method and/or the like.

The memory unit 1007 may comprise a single memory unit, a plurality of memory units, external and/or internal memory units.

In addition, the computer system may comprise a network interface 1003 arranged to receive and transmit data to/from the user, other application and/or the like.

A computer program product including a computer usable medium having computer program logic stored therein to enable a control unit of computer system to perform the method is provided.

Embodiments disclose a method for digital file flow management, comprising the following steps:

a) Constructing a logical map of provenance among a set of digital files or file identifiers;

b) Communicating all or part of the said provenance information to a user;

c) Using the said provenance information to modulate the effect of user actions;

d) Updating the said logical map in conformity with changes in the said set of digital files or file identifiers.

In some embodiments, the files in step (a) are stored on the user's computer, are accessible via an intranet, are accessible the world wide web, are selected by the user, are uploaded by one or more users to a server on which the method is implemented, and/or the like.

In some embodiments, said provenance relationships are recorded in whole or in part at the time of creation, saving, copying or renaming of said files, and/or are reconstructed by analysis of the content of said files. In some embodiments the analysis of the content of said files is supplemented by use of metadata associated with said files; said metadata may include the dates of creation and/or modification of said files.

The analysis may use differences in respect of content elements that are common to some but not all of said files, where said differences may be context-free, hierarchical, and/or hierarchically contexted.

The content elements may be vocabulary items, or approximately matched strings of symbols. In some embodiments said strings are of letters and punctuation in natural language. The matching of strings includes syntactic analysis and/or semantic analysis. Said strings may be specifications of an object or an executable task in a formal language.

Said content elements may in some embodiments be approximately matched images or parts of images, approximately matched specifications of CAD components, approximately matched segments of 3D scan data, approximately matched segments of geological data, and/or approximately matched segments of three-dimensional extraction systems for below-ground resources.

Said three-dimensional extraction systems may be mines and/or wells for solid resources.

Furthermore, said content elements may in some embodiments be approximately matched segments of audio recordings, other playable audio material, approximately matched segments of video recordings or other playable video material, approximately matched segments of multi-media records, approximately matched segments of music scores, approximately matched segments of records in a geographical information system, approximately matched segments of architectural plans, approximately matched structures in virtual environments, or approximately matched structures in computer games.

In some embodiments, provenance information is communicated by means of a descent tree, and/or provenance labels within a view of individual files. The provenance may include creation of one file by modifying a copy of another and saving the result, thus having provenance from said other file. The provenance may include incorporation in a modified version of one file of all or part of another set of data, said modified version then having provenance from said set of data. The provenance may include direct reference in one file to the content of another, the first said file then having provenance from the second said file. The provenance may include allusion in one file to the content of another, the first said file then having provenance from the second said file. The provenance may include in one file a hyperlink to another file, the first said file then having provenance from the second said file.

In some embodiments, the analysis of the content of said files derives the directions of the descent relationships according to stored dates, a later file related to an earlier file having descent from said earlier file.

In some embodiments, said analysis of the content of said files derives directions from content in said files.

In some embodiments, said construction of a descent tree exploits the condition that it must be a directed graph where every differentiator sub-graph has a unique root.

In some embodiments, said construction of a descent tree exploits assigns a strong presumption of direct descent between a pair of files whose similarity score is high and whose dissimilarity score is low, in relation to the scores of other pairs.

In some embodiments, said construction of a descent tree exploits assigns a strong presumption of direct descent where a differentiator is shared among a small set of files, in relation to the sets shared by other differentiators.

In some embodiments, said construction of a descent tree exploits assigns a strong presumption of a node being a leaf node of a differentiator set if it is far from central to that set, relative to other members of that set, or is shared among a small set of files, in relation to the sets shared by other differentiators.

In some embodiments, said construction of a descent tree exploits assigns a strong presumption to said leaf node being in a direct descent relation to the most similar member of said differentiator set.

In some embodiments, the assignment of directions in a descent tree uses the acyclicity of the required graph to infer directional assignments of links from known or presumed directions of other links. In some embodiments, known or presumed direction is found by user input, or derived therefrom by successive application of the inference method. In some embodiments, known or presumed direction is found by semantic analysis, or derived therefrom by successive application of the inference method.

In some embodiments, where assignments of direction constructed to fit temporary presumptions are tested for satisfying the constraints that every differentiator set shall be connected and have a unique root, and presumptions are recursively modified until a best fit to these constraints is reached.

In some embodiments, a list of collaborators is maintained, and every version file is associated with the identity of the creator of that version. Said list of collaborators may be modified by any user on said list, by means provided to add or delete elements of said list, only by a user with special authority.

In some embodiments, displays showing files or their contents associate creators with particular files or blocks of content. Said display may show file icons in rows or in columns corresponding to particular collaborators, may show file content in columns corresponding by local or by overall rule to particular collaborators, and may show file content color-coded by a local or by overall rule to indicate particular collaborators.

In some embodiments, the step of displaying displays all or part of the descent tree as a two-dimensional or three-dimensional diagram, with labels on parts of a display of file content according to provenance.

In some embodiments, the descent tree is non-uniformly set out as a diagram. The non-uniformity may be achieved by user-adjustable manipulation of perspective.

In some embodiments, a set of nodes in the descent tree may be replaced for display by a cluster. In some embodiments, a cluster is defined by mutual similarity among its files, and/or by descent connections among its files.

In some embodiments, a modulation enables the user to see sets of files descended from, or ancestral to, a user-selected file, all or any of a user-selected plurality of files. The modulation may enable the user to work with the set of files corresponding to leaf nodes. The set of files, optionally with additions or deletions, may be copied, downloaded or uploaded to permit further operations by said or another user, may be opened in an integrated multi-file editor.

In some embodiments, a user may drag, drop, delete, upload, download, save or otherwise add or remove digital files or file identifiers from said set, whereupon provenance relations within the set are automatically updated by means used as in step (a).

In some embodiments, said provenance information is used to support the management of work flow in a project.

In some embodiments, an added file or file identifier may constitute background or comment useful for further work on a project involving said set of digital files, and optionally as a reference for a version contributed by said user. Said added file or file identifier may be a bug report or information relevant to discussion of a bug. The user may enter the appropriate provenance data to link said added file or file identifier to said version, as a direct ancestor of said version. The background files may be displayed to a subset of the collaborator list, selected by said user.

In some embodiments, said two-dimensional or three-dimensional diagram uses a spatial direction to signify earlier or later position in time. The position in said spatial direction may be assigned in uniformly scaled proportion to position in time, to match un-scaled sequence to position in time.

In some embodiments, a time bar in the chosen direction is included in the display, where a user-movable marker on said bar acts as a time selector. In some embodiments, a project view matching the selected time is displayed, is an integrated multi-file display. In some embodiments, said multi-file display permits editing when the selected time is the present.

In some embodiments, said time selector may be limited to a chosen region of a files or a set of matching regions in multiple files. The display of a regionally regressed version of the current files or set of files may be used to create a new file incorporating the regressed material inside said region and the current material outside it.

In some embodiments, provenance information is used to limit searches. The search may be backward in descent from a chosen node, forward in descent from a chosen node, for the root occurrence of an item sought, or for the leaf occurrences of an item sought.

In some embodiments, the files where hits are found are highlighted in a descent display. In some embodiments, a context-providing window is available for hits, where motion of a time slider moves the display through hits according to time. Said context-providing window may show all files judged to be relevant at the chosen time by use of an integrated multi-file display. In some embodiments, said files judged to be relevant are those constituting leaf nodes of the descent tree or of its restriction to search hits, as restricted by omission of all nodes more recent than the selected time.

In some embodiments, said multi-file display shows all files judged relevant at the chosen time, where said files judged relevant are those constituting leaf nodes of the descent tree as restricted by omission of all nodes more recent than the selected time.

In some embodiments, said context-providing window uses variable compression of the content of the file or files shown, with least compression near the search hits.

In some embodiments, said multi-file display uses variable compression of the content of the file or files shown.

In some embodiments, the view shown is independent of which user sees it, is customised to the current user. In some embodiments, the current user is shown next to the displayed time line.

In some embodiments, at each time a canonical reference version exists, and variants are shown by their differences from this version. In some embodiments, at each time variants are shown by their differences from the most recent version created by the current user, if such a version exists. In some embodiments, at each time variants are shown by their differences from the most recent version approved by a user with specific authority. In some embodiments, at each time variants are shown by their differences from the version within the set of current leaf nodes that is most central to said set. In some embodiments, at each time variants are shown by their differences from a version selected by the current user. In some embodiments, at each time variants are shown by their differences from the most recent version for which there was consensus agreement. In some embodiments, at each time variants are shown by their differences from the most recent version to be part of the descent history of all versions which are leaf nodes at the time displayed.

In some embodiments, provenance information is used to guide navigation among the files whose icons are displayed.

In some embodiments, all the files in the set are successive versions of a wiki. Versions of a wiki may be included among a larger set of files.

In some embodiments, all the files in the set are submissions to a chat session, and direct descent is defined by direct response. The default submission parental to a second submission may be the most recent submission in view when the user begins typing said second submission. The user may modify the default selection.

In some embodiments, a user may second a proposed change by another user, a user may withdraw a proposed change in favor of the existing displayed reference version, or of a change proposed by another user. In some embodiments, a user may directly modify only a proposed change by said user. In some embodiments, a user with authority may officially accept into the reference version, or reject, a change proposed by another user. A rejected change remains visible only to its proposer (for whom it is then marked as rejected), and optionally to users of administrator-level tools. A rejected change may remain visible to users with higher editing privileges, if they so choose.

In some embodiments, a record is kept of a user's proposed changes and additions, their magnitude, and their durability in the later evolution of a document, of the user's seconding of proposed changes by other users, and of the user's withdrawals in favor of the reference version or proposed changes by other users. Said record may be used to construct a measure of the user's contributions as perceived by other users and of the user's tendency to seek consensus. In some embodiments, higher scores are used automatically in part as a basis for granting a user authority to make changes that immediately become part of the current reference version, or to approve the proposed changes of others.

Some embodiments of a system for digital file flow management are disclosed; comprising the following steps:
i) Constructing on a computer a logical map of provenance among a set of digital files or file identifiers;
ii) Communicating all or part of said provenance information to a user;
iii) Using said provenance information to modulate the effect of user actions upon the output of said computer.

In some embodiments, said system is incorporated in the operating system of said computer.

In some embodiments, said system operates as an application running on said computer.

In some embodiments, said system operates as a server on said computer, providing a service to a user via an intranet, local area network or internet.

In some embodiments, said system functions upon being called initiated directly by the user in some embodiments, said system provides services that may be called upon by another application. The application may provide services specific to files of a type used by said application, enabling said system to better achieve step (i).

In some embodiments, said logical map is stored in an object-oriented database on said computer.

In some embodiments, said logical map is stored in a relational database on said computer.

In some embodiments, said logical map is stored in a matrix structure on said computer.

Some embodiments disclose a computer program product on a storage medium performing the following steps:
i) Constructing on a computer a logical map of provenance among a set of digital files or file identifiers;
ii) Communicating all or part of said provenance information to a user;
iii) Using said provenance information to modulate the effect of user actions upon the output of said computer.

In the drawings and specification, there have been disclosed exemplary embodiments of the invention. However, many variations and modifications can be made to these embodiments without substantially departing from the principles of the present invention. Accordingly, although specific terms are employed, they are used in a generic and descriptive sense only and not for purposes of limitation, the scope of the invention being defined by the following claims.

What is claimed is:

1) A method for enabling flow management of digital objects, comprising the following steps
determining a set of digital objects comprising at least two digital objects,
determining provenance data of the digital objects by comparing data of the digital objects within the set of digital objects,
constructing a logical map of provenance among the set of digital objects,
displaying at least part of said provenance data to at least one user, and
using the provenance data to modulate the effect of a display-modifying or information-seeking action of the user.

2. A method according to claim 1, further comprising the step of updating said logical map in conformity with additions, deletions and modifications in said set of digital objects

3. A method according to claim 1, wherein each digital object comprises a digital file.

4. A method according to claim 1, wherein determining provenance information is performed by comparing the structured data of the digital objects.

5. A method according to claim 1, where said provenance data are determined in whole or in part at the time of creation, saving, copying, renaming of said digital objects, by analysing content of said digital objects, and/or supplemented by use of metadata associated with said digital object.

6. A method according to claim 1, further comprising the step of creating similarity and dissimilarity matrices and differentiator sets of the set of digital objects.

7. A method according to claim 1, further comprising the step of sorting the digital objects into a list.

8. A method according to claim 1, further comprising the step of connecting elements of each digital object.

9. A method according to claim 1, further comprising the step of constructing the digital objects into groups.

10. A method according to claim 1, wherein the user action comprises alteration in a digital object and the map is updated with a new digital object comprising the alteration.

11. A method according to claim 1, wherein the digital objects are documents in different digital document formats.

12. A method according to claim 1, wherein the user action comprises adding a digital object to the set, accepting a change within a digital object, undo a change, selection, a search, moving a time line indicator and/or the like.

13. A method according to claim 12, wherein adding a digital object provenance data of the digital objects is determined by comparing data of the newly added digital object with data of the set of digital objects.

14. A computer system for flow management of digital objects comprising a control unit arranged to determine a set of digital objects comprising at least two digital objects and provenance data of the digital objects, to construct a logical map of provenance among the set of digital objects; the control unit further being arranged to display at least part of said provenance data to at least one user and to use the provenance data to modulate the effect of an action of the user.

15. A computer system according to claim 14, wherein the control unit is further arranged to update said logical map in conformity with changes in said set of digital objects resulting from the action.

16. A computer system according to claim 14, wherein the computer system comprises an Internet server, a local computer, and/or the like.

17. A computer program product including a computer usable medium having computer program logic stored therein to enable a control unit of an electronic device to perform the steps of:
determining a set of digital objects comprising at least two digital objects
determining provenance data of the digital objects by comparing data of the digital objects within the set of digital objects,
constructing a logical map of provenance among the set of digital objects;
displaying at least part of said provenance data to at least one user;
using the provenance data to modulate the effect of a display-modifying or information-seeking action of the user upon the system embodying the method, and
updating said logical map in conformity with additions, deletions and modifications by any user in said set of digital objects.
